(19) United States
(12) Patent Application Publication
(10) Pub. No.: US 2026/0195156 A1
(43) Pub. Date: Jul. 9, 2026

(54) IMAGE DISPLAY APPARATUS

(71) Applicant: LG ELECTRONICS INC., Seoul (KR)

(72) Inventors: Kyungnam Bae, Seoul (KR); Donghee Lee, Seoul (KR); Obong An, Seoul (KR); Sangjin Ahn, Seoul (KR)

(73) Assignee: LG ELECTRONICS INC., Seoul (KR)

(21) Appl. No.: 19/442,476

(22) Filed: Jan. 7, 2026

(30) Foreign Application Priority Data
Jan. 8, 2025 (WO) PCT/KR2025/000453

(51) Int. Cl. G06F 9/455; A63F 13/24; G06F 3/023; G06F 3/0354; G06F 3/038; G06F 3/041; G06F 3/14

(52) U.S. Cl. CPC G06F 9/45508; A63F 13/24; G06F 3/023; G06F 3/03541; G06F 3/038; G06F 3/0416; G06F 3/1454

(57) ABSTRACT

An image display apparatus according to an embodiment of the present disclosure includes a display, a signal processing device configured to output an image signal to the display, a first interface configured to receive an input signal from an input device, and a second interface wiredly connected to an external device, and the signal processing device is configured to execute an operating system, execute an application on the operating system, and execute an emulator operating based on the input signal from the first interface, and transmit a signal corresponding to the input signal to the executed application or to an external device. Accordingly, it is possible to control the application or the external device based on the input signal from the input device.

### CROSS-REFERENCE TO RELATED APPLICATION

Pursuant to 35 U.S.C. § 119(a), this application claims priority to PCT Application No. PCT/KR2025/000453, filed on Jan. 8, 2025, the entity of which is incorporated by reference into the present application.

### BACKGROUND

### 1. Field

The present disclosure relates to an image display apparatus, and more particularly, to an image display apparatus capable of controling an application or control an external device based on an input signal from an input device.

### 2. Description of the Related Art

An image display apparatus is an apparatus that displays an image through a display.

Meanwhile, the image display apparatus can be configured to receive an input signal from an input device, and perform a predetermined operation based on the input signal from the input device.

Meanwhile, when an external device is connected to the image display apparatus, a method for controlling the external device is studied.

### SUMMARY

An object of the present disclosure is to provide an image display apparatus capable of controling an application or control an external device based on an input signal from an input device.

Another object of the present disclosure is to provide an image display apparatus capable of controling the application or control the external device based on various input signals.

Yet another object of the present disclosure is to provide an image display apparatus capable of controling the external device based on the input signal from the input device.

In accordance with an embodiment of the present disclosure, an image display apparatus includes a display, a signal processing device configured to output an image signal to the display, a first interface configured to receive an input signal from an input device, and a second interface wiredly connected to an external device, and the signal processing device is configured to execute an operating system, execute an application on the operating system, and execute an emulator operating based on the input signal from the first interface, and transmit a signal corresponding to the input signal to the executed application or to an external device.

Meanwhile, the signal processing device can be configured to execute a kernel, execute the operating system on the kernel, and execute the application on the operating system.

Meanwhile, the emulator can be configured to receive the input signal from the first interface through the kernel, or transmit the signal corresponding to the input signal to the executed external device through the kernel.

Meanwhile, the signal processing device can be further configured to execute a manager configured to determine whether to transmit the signal corresponding to the input signal to the executed application or the external device based on the signal from the emulator.

Meanwhile, the emulator can be executed in the operating system.

Meanwhile, the manager can be executed in the operating system.

Meanwhile, in response to control of the external device being required, the signal processing device can be configured to set first data for controlling the external device to a first value and set second data for controlling the application to a second value.

Meanwhile, in response to control of the application being required, the signal processing device can be configured to set the first data for controlling the external device to a third value and set the second data for controlling the application to a fourth value.

Meanwhile, in response to control of the application and control of the external device being required, the signal processing device can be configured to set the first data for controlling the external device to the first value and set the second data for controlling the application to a fifth value.

Meanwhile, in response to control of the external device being required, the signal processing device can be configured to convert the input signal into a data packet and transmit the converted packet to the external device.

Meanwhile, in response to the input device being a keyboard, the emulator can be configured to convert an input signal of the keyboard into a data packet, and the second interface can be configured to transmit the converted packet to the external device.

Meanwhile, in response to the input device being a mouse, the emulator can be configured to convert an input signal of the mouse into the data packet and the second interface can be configured to transmit the converted packet to the external device.

Meanwhile, in response to receiving a touch input signal of the display, the emulator can be configured to convert a touch input signal of the display into the data packet and the second interface can be configured to transmit the converted packet to the external device.

Meanwhile, in response to the input device being a remote control device, the emulator can be configured to convert an input signal of the remote control device into the data packet and the second interface can be configured to transmit the converted packet to the external device.

Meanwhile, in response to the input device being a game pad, the emulator can be configured to convert an input signal of the game pad into the data packet and the second interface can be configured to transmit the converted packet to the external device.

Meanwhile, in response to control of the external device being required, the signal control device can be configured to convert an input signal into the data packet, and the second interface can be configured to transmit the converted packet to the external device and receive an image signal or an audio signal from the external device.

Meanwhile, the signal processing device can be configured to display an image corresponding to the image signal received through the second interface on the display.

Meanwhile, the second interface can be configured to transmit a DC voltage to the external device in response to receiving the image signal or the audio signal.

Meanwhile, the second interface can be configured to receive the DC voltage from the external device in response to receiving the image signal or the audio signal.

Meanwhile, the signal processing device can be configured to display a first image corresponding to the image signal received through the second interface and a second image corresponding to the application together.

Meanwhile, the signal processing device can be configured to perform an input control for any one of the first image and the second image based on an event by the input signal.

Meanwhile, the signal processing device can be configured to display an image corresponding to the application in response to a first event based on the input signal while displaying the image corresponding to the image signal received through the second interface in a full screen.

In accordance with an embodiment of the present disclosure, an image display apparatus includes a display, a signal processing device configured to output an image signal to the display, a first interface configured to receive an input signal from an input device, and a second interface wiredly connected to an external device, and the signal processing device is configured to execute an operating system, execute an application on the operating system, and execute an emulator converting the input signal from the first interface into a data packet, and the second interface is configured to transmit the converted packet to an external device.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing an image display apparatus according to an embodiment of the present disclosure;

FIG. 2 is an example of an internal block diagram of the image display apparatus;

FIG. 3 is an example of an internal block diagram of a signal processing device of FIG. 2;

FIG. 4A is a diagram showing a method of controlling a remote controller of FIG. 2;

FIG. 4B is an internal block diagram of the remote controller of FIG. 2;

FIG. 5 illustrates another example of an internal block diagram of the image display apparatus of FIG. 1;

FIG. 6 illustrates an example of an internal block diagram of an image display apparatus according to an embodiment of the present disclosure;

FIGS. 7A and 7B are diagrams referred to for description of FIG. 6;

FIG. 8 illustrates an example of an internal block diagram of the signal processing device of FIG. 6; and

FIGS. 9A to 15D are diagrams referred to for description of an operation of FIG. 8.

### DETAILED DESCRIPTION OF THE PREFERRED EMBODIMENTS

Hereinafter, the present disclosure will be described in detail with reference to the accompanying drawings.

Regarding constituent elements used in the following description, suffixes “module” and “unit” are given only in consideration of ease in the preparation of the specification, and do not have or serve as different meanings. Accordingly, the suffixes “module” and “unit” can be used interchangeably.

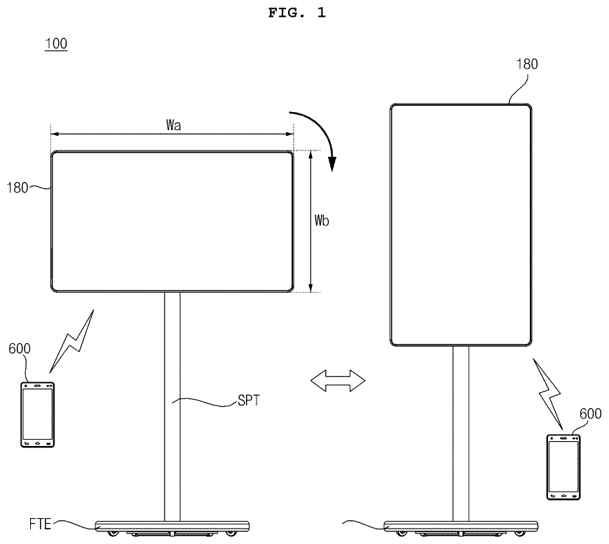

FIG. 1 is a diagram showing an image display apparatus according to an embodiment of the present disclosure.

Referring to FIG. 1, an image display apparatus 100 according to an embodiment of the present disclosure comprises a display 180.

Meanwhile, the image display apparatus 100 can further include a base FTE, and a support frame SPT supporting between the base FTE and the display 180.

Meanwhile, the image display apparatus 100 can be a movable image display apparatus.

For example, at least one wheel is disposed below the base FTE to operate in the case in which the image display apparatus 100 moves.

Meanwhile, the display 180 in the image display apparatus 100 according to an embodiment of the present disclosure can be rotatable.

For example, the display 180 in the image display apparatus 100 rotates in a horizontal mode in which a screen ratio is Wa:Wb, which can be switched to a vertical mode in which the screen ratio is Wb:Wa.

As another example, the display 180 in the image display apparatus 100 rotates in the vertical mode in which the screen ratio is Wb:Wa, which can be switched to the horizontal mode in which the screen ratio is Wa:Wb.

Meanwhile, the image display apparatus 100 according to an exemplary embodiment of the present disclosure can be wiredly connected or wirelessly connected to an external battery device 500 or a peripheral electronic device such as a mobile terminal 600, etc.

For example, the image display apparatus 100 according to an exemplary embodiment of the present disclosure can be configured to receive an image signal from the mobile terminal 600, etc.

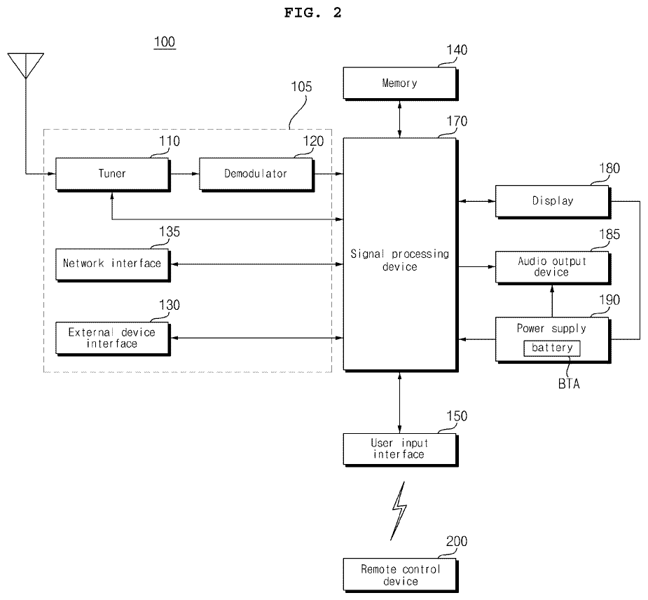

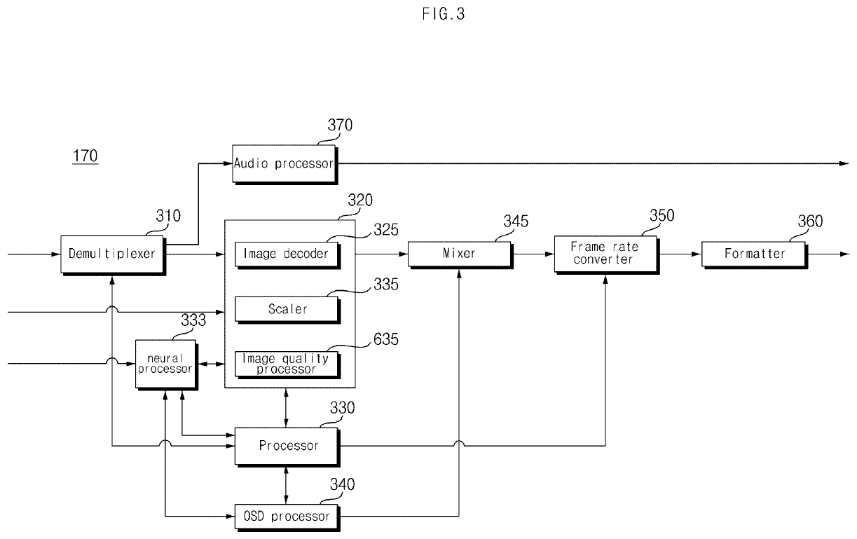

Meanwhile, the image display apparatus 100 according to an exemplary embodiment of the present disclosure comprises a battery BTA of FIG. 2.

Meanwhile, a power supply 190 of FIG. 2 in the image display apparatus 100 supplies charging current to the battery BTA to charge the battery BTA upon a charging mode of the battery BTA.

Meanwhile, the image display apparatus 100 of FIG. 1 can be a TV, a monitor, etc.

FIG. 2 is an example of an internal block diagram of the image display apparatus of FIG. 1.

Referring to FIG. 2, the image display apparatus 100 according to an embodiment of the present disclosure comprises an image receiver 105, an external apparatus interface 130, a memory 140, a user input interface 150, a sensor device (not shown), a signal processing device 170, a display 180, and an audio output device 185.

The image receiver 105 can include a tuner 110, a demodulator 120, a network interface 135, and an external apparatus interface 130.

Meanwhile, unlike the figure, the image receiver 105 can include only the tuner 110, the demodulator 120, and the external apparatus interface 130. That is, the network interface 135 cannot be included.

The tuner 110 selects an RF broadcast signal corresponding to a channel selected by a user or all pre-stored channels among radio frequency (RF) broadcast signals received through an antenna (not shown). In addition, the selected RF broadcast signal is converted into an intermediate frequency signal, a baseband image, or an audio signal.

For example, the tuner 110 converts the selected RF broadcasting signal into a digital IF signal (DIF) in the case in which the selected RF broadcasting signal is a digital broadcasting signal, and converts the selected RF broadcasting signal into an analog baseband image or voice signal (CVBS/SIF) in the case in which the selected RF broadcasting signal is an analog broadcasting signal. That is, the tuner 110 can process the digital broadcasting signal or the analog broadcasting signal. The analog baseband image or voice signal outputted from the tuner 110 can be directly inputted into the signal processing device 170.

Meanwhile, the tuner 110 can include a plurality of tuners for receiving broadcast signals of a plurality of channels. Alternatively, a single tuner that simultaneously receives broadcast signals of a plurality of channels is also available.

The demodulator 120 receive the converted digital IF signal DIF from the tuner 110 and performs a demodulation operation.

The demodulator 120 can be configured to perform demodulation and channel decoding and then output a stream signal TS. At this time, the stream signal can be a multiplexed signal of an image signal, an audio signal, or a data signal.

The stream signal output from the demodulator 120 can be input to the signal processing device 170. The signal processing device 170 performs demultiplexing, image/audio signal processing, and the like, and then outputs an image to the display 180 and outputs audio to the audio output device 185.

The external apparatus interface 130 can be configured to transmit or receive data with a connected external apparatus (not shown), e.g., a set-top box 50. To this end, the external apparatus interface 130 can include an A/V input and output device (not shown).

The external apparatus interface 130 can be connected in wired or wirelessly to an external apparatus, such as a digital versatile disk (DVD), a Blu ray, a game equipment, a camera, a camcorder, a computer (note book), and a set-top box, and can be configured to perform an input/output operation with an external apparatus.

The A/V input and output device can be configured to receive image and audio signals from an external apparatus. Meanwhile, a wireless transceiver (not shown) can be configured to perform short-range wireless communication with other electronic apparatus.

Through the wireless transceiver (not shown), the external apparatus interface 130 can exchange data with an adjacent mobile terminal 600. In particular, in a mirroring mode, the external apparatus interface 130 can be configured to receive device information, executed application information, application image, and the like from the mobile terminal 600.

The network interface 135 provides an interface for connecting the image display apparatus 100 to a wired/wireless network including the Internet network. For example, the network interface 135 can be configured to receive, via the network, content or data provided by the Internet, a content provider, or a network operator.

Meanwhile, the network interface 135 can include a wireless transceiver (not shown).

The memory 140 can store a program for each signal processing and control in the signal processing device 170, and can store signal-processed image, audio, or data signal.

In addition, the memory 140 can serve to temporarily store image, audio, or data signal input to the external apparatus interface 130. In addition, the memory 140 can store information on a certain broadcast channel through a channel memory function, such as a channel map.

Although FIG. 2 illustrates that the memory is provided separately from the signal processing device 170, the scope of the present disclosure is not limited thereto. The memory 140 can be included in the signal processing device 170.

The user input interface 150 transmits a signal input by the user to the signal processing device 170 or transmits a signal from the signal processing device 170 to the user.

For example, it can be configured to transmit/receive a user input signal, such as power on/off, channel selection, screen setting, etc., from a remote controller 200, can transfer a user input signal input from a local key (not shown), such as a power key, a channel key, a volume key, a set value, etc., to the signal processing device 170, can transfer a user input signal input from a sensor device (not shown) that senses a user's gesture to the signal processing device 170, or can be configured to transmit a signal from the signal processing device 170 to the sensor device (not shown).

The signal processing device 170 can demultiplex the input stream through the tuner 110, the demodulator 120, the network interface 135, or the external apparatus interface 130, or process the demultiplexed signals to generate and output a signal for image or audio output.

For example, the signal processing device 170 receives a broadcast signal received by the image receiver 105 or an HDMI signal, and perform signal processing based on the received broadcast signal or the HDMI signal to thereby output a processed image signal.

The image signal processed by the signal processing device 170 is input to the display 180, and can be displayed as an image corresponding to the image signal. In addition, the image signal processed by the signal processing device 170 can be input to the external output apparatus through the external apparatus interface 130.

The audio signal processed by the signal processing device 170 can be output to the audio output device 185 as an audio signal. In addition, audio signal processed by the signal processing device 170 can be input to the external output apparatus through the external apparatus interface 130.

Although not shown in FIG. 2, the signal processing device 170 can include a demultiplexer, an image processor, and the like. That is, the signal processing device 170 can be configured to perform a variety of signal processing and thus it can be implemented in the form of a system on chip (SOC). This will be described later with reference to FIG. 3.

In addition, the signal processing device 170 can control the overall operation of the image display apparatus 100. For example, the signal processing device 170 can control the tuner 110 to control the tuning of the RF broadcast corresponding to the channel selected by the user or the previously stored channel.

In addition, the signal processing device 170 can control the image display apparatus 100 according to a user command input through the user input interface 150 or an internal program.

Meanwhile, the signal processing device 170 can control the display 180 to display an image. At this time, the image displayed on the display 180 can be a still image or a moving image, and can be a 2D image or a 3D image.

Meanwhile, the signal processing device 170 can display a certain object in an image displayed on the display 180. For example, the object can be at least one of a connected web screen (newspaper, magazine, etc.), an electronic program guide (EPG), various menus, a widget, an icon, a still image, a moving image, and a text.

Meanwhile, the signal processing device 170 can recognize the position of the user based on the image photographed by a photographing device (not shown). For example, the distance (z-axis coordinate) between a user and the image display apparatus 100 can be determined. In addition, the x-axis coordinate and the y-axis coordinate on the display 180 corresponding to a user position can be determined.

The display 180 generates a driving signal by converting an image signal, a data signal, an OSD signal, a control signal processed by the signal processing device 170, an image signal, a data signal, a control signal, and the like received from the external apparatus interface 130.

Meanwhile, the display 180 can be configured as a touch screen and used as an input device in addition to an output device.

The audio output device 185 receives a signal processed by the signal processing device 170 and outputs it as an audio.

The photographing device (not shown) photographs a user. The photographing device (not shown) can be implemented by a single camera, but the present disclosure is not limited thereto and can be implemented by a plurality of cameras. Image information photographed by the photographing device (not shown) can be input to the signal processing device 170.

The signal processing device 170 can sense a gesture of the user based on each of the images photographed by the photographing device (not shown), the signals detected from the sensor device (not shown), or a combination thereof.

The power supply 190 supplies corresponding power to the image display apparatus 100.

Particularly, the power can be supplied to a signal processing device 170 which can be implemented in the form of a system on chip (SOC), a display 180 for displaying an image, and an audio output device 185 for outputting an audio.

Specifically, the power supply 190 can include a converter to convert the level of the input voltage.

For example, the power supply 190 can include an ac/dc converter and a dc/dc converter in the case in which the input voltage is an alternating current voltage.

As another example, the power supply 190 can include the dc/dc converter in the case in which the input voltage is a direct current voltage.

Meanwhile, the power supply 190 includes the battery BTA.

The remote controller 200 transmits the user input to the user input interface 150. To this end, the remote controller 200 can use Bluetooth, a radio frequency (RF) communication, an infrared (IR) communication, an Ultra Wideband (UWB), ZigBee, or the like. In addition, the remote controller 200 can be configured to receive the image, audio, or data signal output from the user input interface 150, and display it on the remote controller 200 or output it as an audio.

Meanwhile, the image display apparatus 100 can be a fixed or mobile digital broadcast receiver capable of receiving digital broadcast.

Meanwhile, a block diagram of the image display apparatus 100 shown in FIG. 2 is a block diagram for an embodiment of the present disclosure. Each component of the block diagram can be integrated, added, or omitted according to a specification of the image display apparatus 100 actually implemented. That is, two or more components can be combined into a single component as needed, or a single component can be split into two or more components. The function performed in each block is described for the purpose of illustrating embodiments of the present disclosure, and specific operation and apparatus do not limit the scope of the present disclosure.

FIG. 3 is an example of an internal block diagram of the signal processing device in FIG. 2.

Referring to the figure, the signal processing device 170 according to an embodiment of the present disclosure can include a demultiplexer 310, an image processor 320, a processor 330, and an audio processor 370. In addition, the signal processing device 170 can further include and a data processor (not shown).

The demultiplexer 310 demultiplexes the input stream. For example, in the case in which an MPEG-2 TS is input, it can be demultiplexed into image, audio, and data signal, respectively. Here, the stream signal input to the demultiplexer 310 can be a stream signal output from the tuner 110, the demodulator 120, or the external apparatus interface 130.

The image processor 320 can be configured to perform signal processing on an input image. For example, the image processor 320 can be configured to perform image processing on an image signal demultiplexed by the demultiplexer 310.

To this end, the image processor 320 can include an image decoder 325, a scaler 335, an image quality processor 635, an image encoder (not shown), a graphic processor 340, a frame rate converter 350, a formatter 360, etc.

The image decoder 325 decodes a demultiplexed image signal, and the scaler 335 performs scaling so that the resolution of the decoded image signal can be output from the display 180.

The image decoder 325 can include a decoder of various standards. For example, a 3D image decoder for MPEG- 2, H.264 decoder, a color image, and a depth image, and a decoder for a multiple view image can be provided.

The scaler 335 can scale an input image signal decoded by the image decoder 325 or the like.

For example, if the size or resolution of an input image signal is small, the scaler 335 can upscale the input image signal, and, if the size or resolution of the input image signal is great, the scaler 335 can downscale the input image signal.

The image quality processor 635 can be configured to perform image quality processing on an input image signal decoded by the image decoder 325 or the like.

For example, the image quality processor 625 can be configured to perform noise reduction processing on an input image signal, extend a resolution of high gray level of the input image signal, perform image resolution enhancement, perform high dynamic range (HDR)-based signal processing, change a frame rate, perform image quality processing suitable for properties of a panel, especially an OLED panel, etc.

The graphic processor 340 generates an OSD signal according to a user input or by itself. For example, based on a user input signal, the graphic processor 340 can generate a signal for displaying various information as a graphic or a text on the screen of the display 180. The generated OSD signal can include various data, such as a user interface screen of the image display apparatus 100, various menu screens, a widget, and an icon. In addition, the generated OSD signal can include a 2D object or a 3D object.

In addition, the graphic processor 340 can generate a pointer that can be displayed on the display, based on a pointing signal input from the remote controller 200. In particular, such a pointer can be generated by a pointing signal processing device, and the graphic processor 340 can include such a pointing signal processing device (not shown). Obviously, the pointing signal processing device (not shown) can be provided separately from the graphic processor 340.

The frame rate converter (FRC) 350 can be configured to convert a frame rate of an input image. Meanwhile, the frame rate converter 350 can output the input image without converting the frame rate.

Meanwhile, the formatter 360 can change a format of an input image signal into a format suitable for displaying the image signal on a display and output the image signal in the changed format.

In particular, the formatter 360 can change a format of an image signal to correspond to a display panel.

Meanwhile, the formatter 360 can also change the format of the video signal.

The processor 330 can control overall operations of the image display apparatus 100 or the signal processing device 170.

For example, the processor 330 can control the tuner 110 to control the tuning of an RF broadcast corresponding to a channel selected by a user or a previously stored channel.

In addition, the processor 330 can control the image display apparatus 100 according to a user command input through the user input interface 150 or an internal program.

In addition, the processor 330 can be configured to transmit data to the network interface 135 or to the external apparatus interface 130.

In addition, the processor 330 can control the demultiplexer 310, the image processor 320, and the like in the signal processing device 170.

Meanwhile, the audio processor 370 in the signal processing device 170 can be configured to perform the audio processing of the demultiplexed audio signal. To this end, the audio processor 370 can include various decoders.

In addition, the audio processor 370 in the signal processing device 170 can process a base, a treble, a volume control, and the like.

The data processor (not shown) in the signal processing device 170 can be configured to perform data processing of the demultiplexed data signal. For example, in the case in which the demultiplexed data signal is a coded data signal, it can be decoded. The encoded data signal can be electronic program guide information including broadcast information, such as a start time and an end time of a broadcast program broadcasted on each channel.

Meanwhile, a block diagram of the signal processing device 170 shown in FIG. 3 is a block diagram for an embodiment of the present disclosure. Each component of the block diagram can be integrated, added, or omitted according to a specification of the signal processing device 170 actually implemented.

In particular, the frame rate converter 350 and the formatter 360 can be provided separately in addition to the image processor 320.

Meanwhile, the signal processing device 170 according to an exemplary embodiment of the present disclosure can further include a neural network processor 333 for learning processing, etc.

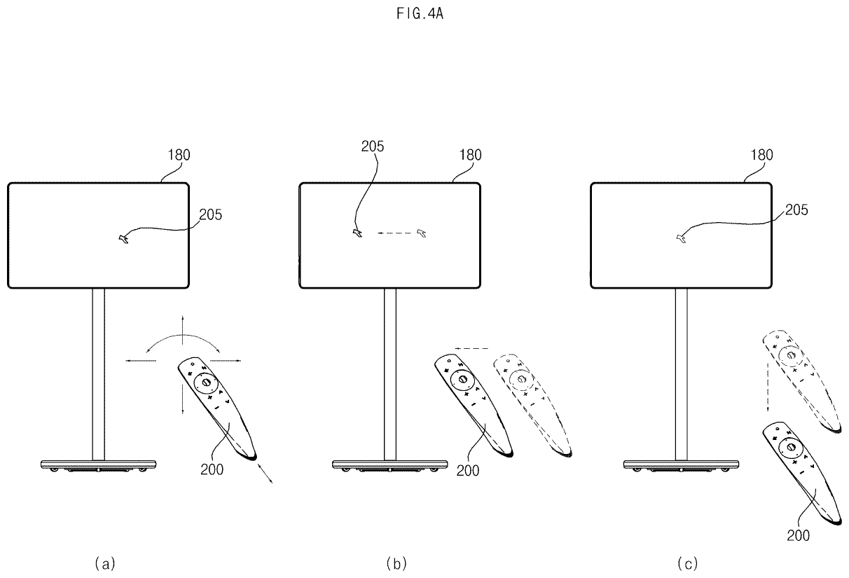

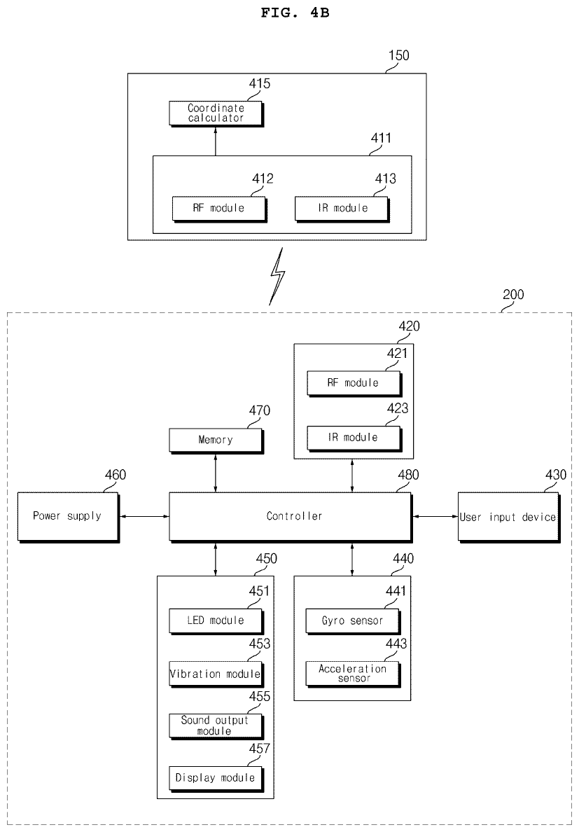

FIG. 4A is a diagram illustrating a control method of a remote controller of FIG. 2.

As shown in FIG. 4A(a), it is illustrated that a pointer 205 corresponding to the remote controller 200 is displayed on the display 180.

The user can move or rotate the remote controller 200 up and down, left and right (FIG. 4A(b)), and back and forth (FIG. 4A(c)). The pointer 205 displayed on the display 180 of the image display apparatus corresponds to the motion of the remote controller 200. Such a remote controller 200 can be referred to as a space remote controller or a 3D pointing apparatus, because the pointer 205 is moved and displayed according to the movement in a 3D space, as shown in the figure.

FIG. 4A(b) illustrates that in the case in which the user moves the remote controller 200 to the left, the pointer 205 displayed on the display 180 of the image display apparatus also moves to the left correspondingly.

Information on the motion of the remote controller 200 detected through a sensor of the remote controller 200 is transmitted to the image display apparatus. The image display apparatus can calculate the coordinate of the pointer 205 from the information on the motion of the remote controller 200. The image display apparatus can display the pointer 205 to correspond to the calculated coordinate.

FIG. 4A(c) illustrates a case where the user moves the remote controller 200 away from the display 180, while pressing a specific button of the remote controller 200. Thus, a selection area within the display 180 corresponding to the pointer 205 can be zoomed in so that it can be displayed to be enlarged. Meanwhile, in the case in which the user moves the remote controller 200 close to the display 180, the selection area within the display 180 corresponding to the pointer 205 can be zoomed out so that it can be displayed to be reduced. Meanwhile, in the case in which the remote controller 200 moves away from the display 180, the selection area can be zoomed out, and in the case in which the remote controller 200 approaches the display 180, the selection area can be zoomed in.

Meanwhile, in the case in which the specific button of the remote controller 200 is pressed, it is possible to exclude the recognition of vertical and lateral movement. That is, in the case in which the remote controller 200 moves away from or approaches the display 180, the up, down, left, and right movements are not recognized, and only the forward and backward movements are recognized. Only the pointer 205 is moved according to the up, down, left, and right movements of the remote controller 200 in a state where the specific button of the remote controller 200 is not pressed.

Meanwhile, the moving speed or the moving direction of the pointer 205 can correspond to the moving speed or the moving direction of the remote controller 200.

FIG. 4B is an internal block diagram of the remote controller of FIG. 2.

Referring to the figure, the remote controller 200 includes a wireless transceiver 425, a user input device 435, a sensor device 440, an output device 450, a power supply 460, a memory 470, and a controller 480.

The wireless transceiver 425 transmits/receives a signal to/from any one of the image display apparatuses according to the embodiments of the present disclosure described above. Among the image display apparatuses according to the embodiments of the present disclosure, one image display apparatus 100 will be described as an example.

In the present embodiment, the remote controller 200 can include an RF module 421 for transmitting and receiving signals to and from the image display apparatus 100 according to a RF communication standard. In addition, the remote controller 200 can include an IR module 423 for transmitting and receiving signals to and from the image display apparatus 100 according to a IR communication standard.

In the present embodiment, the remote controller 200 transmits a signal containing information on the motion of the remote controller 200 to the image display apparatus 100 through the RF module 421.

In addition, the remote controller 200 can be configured to receive the signal transmitted by the image display apparatus 100 through the RF module 421. In addition, if necessary, the remote controller 200 can be configured to transmit a command related to power on/off, channel change, volume change, and the like to the image display apparatus 100 through the IR module 423.

The user input device 435 can be implemented by a keypad, a button, a touch pad, a touch screen, or the like. The user can operate the user input device 435 to input a command related to the image display apparatus 100 to the remote controller 200. in the case in which the user input device 435 includes a hard key button, the user can input a command related to the image display apparatus 100 to the remote controller 200 through a push operation of the hard key button. in the case in which the user input device 435 includes a touch screen, the user can touch a soft key of the touch screen to input the command related to the image display apparatus 100 to the remote controller 200. In addition, the user input device 435 can include various types of input means, such as a scroll key, a jog key, etc., which can be operated by the user, and the present disclosure does not limit the scope of the present disclosure.

The sensor device 440 can include a gyro sensor 441 or an acceleration sensor 443. The gyro sensor 441 can sense information regarding the motion of the remote controller 200.

For example, the gyro sensor 441 can sense information on the operation of the remote controller 200 based on the x, y, and z axes. The acceleration sensor 443 can sense information on the moving speed of the remote controller 200. Meanwhile, a distance measuring sensor can be further provided, and thus, the distance to the display 180 can be sensed.

The output device 450 can output an image or an audio signal corresponding to the operation of the user input device 435 or a signal transmitted from the image display apparatus 100. Through the output device 450, the user can recognize whether the user input device 435 is operated or whether the image display apparatus 100 is controlled.

For example, the output device 450 can include an LED module 451 that is turned on in the case in which the user input device 435 is operated or a signal is transmitted/received to/from the image display apparatus 100 through the wireless transceiver 425, a vibration module 453 for generating a vibration, an audio output module 455 for outputting an audio, or a display module 457 for outputting an image.

The power supply 460 supplies power to the remote controller 200. in the case in which the remote controller 200 is not moved for a certain time, the power supply 460 can stop the supply of power to reduce a power waste. The power supply 460 can resume power supply in the case in which a certain key provided in the remote controller 200 is operated.

The memory 470 can store various types of programs, application data, and the like necessary for the control or operation of the remote controller 200. If the remote controller 200 wirelessly transmits and receive a signal to/from the image display apparatus 100 through the RF module 421, the remote controller 200 and the image display apparatus 100 transmit and receive a signal through a certain frequency band. The controller 480 of the remote controller 200 can store information regarding a frequency band or the like for wirelessly transmitting and receiving a signal to/from the image display apparatus 100 paired with the remote controller 200 in the memory 470 and can refer to the stored information.

The controller 480 controls various matters related to the control of the remote controller 200. The controller 480 can be configured to transmit a signal corresponding to a certain key operation of the user input device 435 or a signal corresponding to the motion of the remote controller 200 sensed by the sensor device 440 to the image display apparatus 100 through the wireless transceiver 425.

The user input interface 150 of the image display apparatus 100 includes a wireless transceiver 151 that can wirelessly transmit and receive a signal to and from the remote controller 200 and a coordinate value calculator 415 that can calculate the coordinate value of a pointer corresponding to the operation of the remote controller 200.

The user input interface 150 can wirelessly transmit and receive a signal to and from the remote controller 200 through the RF module 412. In addition, the user input interface 150 can be configured to receive a signal transmitted by the remote controller 200 through the IR module 413 according to a IR communication standard.

The coordinate value calculator 415 can correct a hand shake or an error from a signal corresponding to the operation of the remote controller 200 received through the wireless transceiver 151 and calculate the coordinate value (x, y) of the pointer 205 to be displayed on the display 180.

The transmission signal of the remote controller 200 inputted to the image display apparatus 100 through the user input interface 150 is transmitted to the controller 180 of the image display apparatus 100. The controller 180 can determine the information on the operation of the remote controller 200 and the key operation from the signal transmitted from the remote controller 200, and, correspondingly, control the image display apparatus 100.

For another example, the remote controller 200 can calculate the pointer coordinate value corresponding to the operation and output it to the user input interface 150 of the image display apparatus 100. In this case, the user input interface 150 of the image display apparatus 100 can be configured to transmit information on the received pointer coordinate value to the controller 180 without a separate correction process of hand shake or error.

For another example, unlike the figure, the coordinate value calculator 415 can be provided in the signal processing device 170, not in the user input interface 150.

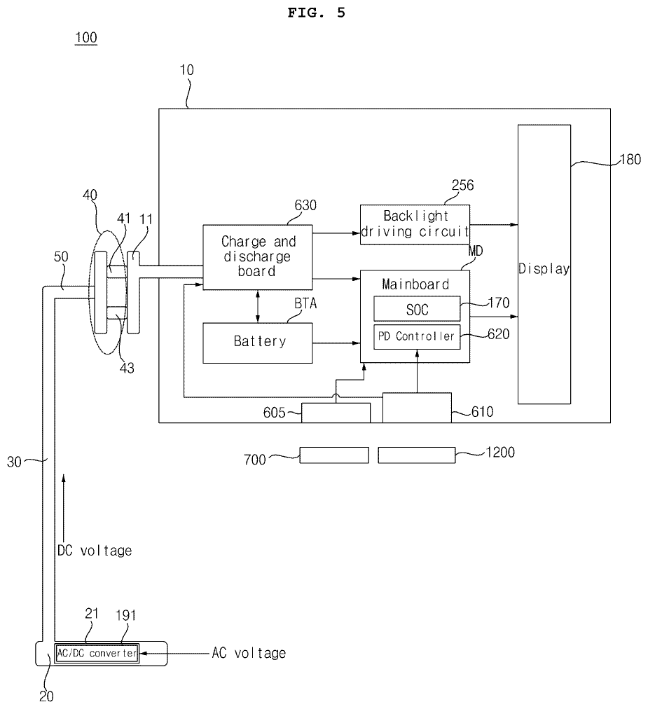

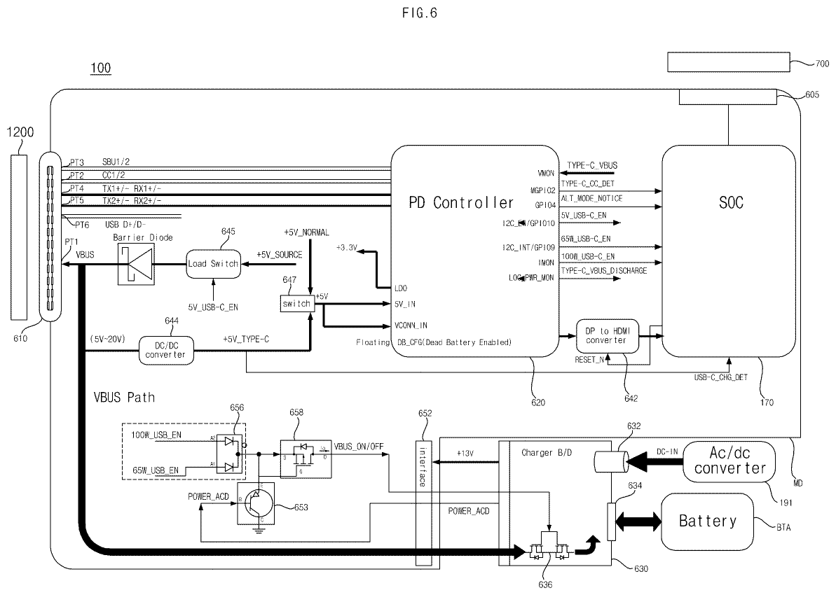

FIG. 5 illustrates another example of an internal block diagram of the image display apparatus of FIG. 1.

Referring to FIG. 5, the image display apparatus 100 according to an exemplary embodiment of the present disclosure can include stands 20, 30, 40, and 50, and a head 10.

The stands 20, 30, 40, and 50 can include a base 20, a pole 30, a rotary connector 40, and a support arm 50.

The stands 20, 30, 40, and 50 can be detachably coupled to the head 10.

The base 20 can include a power board 21. That is, the power board 21 can be embedded in the base 20.

Meanwhile, the power board 21 can be configured to receive an AC voltage from an external power supply connected through a plug CWa, and convert the received AC voltage into a DC voltage.

Meanwhile, the power board 21 can supply the DC voltage to the head 10 through one or more probe pins 41 and 43 included in a connector 40.

Meanwhile, the power board 21 can include an AC/DC converter 191 which can be configured to convert the AC voltage into the DC voltage.

Meanwhile, unlike FIG. 5, the AC/DC converter 191 is also enabled to be provided separately from the power board 21.

The power board 21 can detect whether the AC/DC converter 191 is connected, and generate a detection signal based on a detection result. The power board 21 can be configured to transmit the generated detection signal to a mainboard MD.

The rotary connector 40 can include one or more probe pins 41 and 43. One or more probe pins 41 and 43 can be pins which electrically connect the head 10 and the stands 20, 30, 40, and 50.

In FIG. 5, it is described as an example that the rotary connector 40 includes two probe pins 41 and 43, but this is just an example.

One or more probe pins 41 and 43 can be connected to a head connector 11 including one or more contact terminals which are in contact with one or more probe pins 41 and 43. The head connector 11 can be a probe pin socket into which the probe pins 41 and 43 are inserted to form an electrical contact.

The head 10 can include the head connector 11, a charge and discharge board 630, a battery BTA, a backlight driving circuit 256, the mainboard MD, and a display 180.

The head connector 11 can include one or more contact terminal for an electrical contact with one or more probe pins 41 and 43.

The head connector 11 can provide the DC voltage supplied from one or more probe pins 41 and 43 to the charge and discharge board 630 through one or more contact terminals.

The head connector 11 can be an interface for an electrical connection between one or more probe pins 41 and 43, and the charge and discharge board 630.

The charge and discharge board 630 can provide the DC voltage supplied from the power board 21 to components provided in the head 10.

The charge and discharge board 630 can provide the DC voltage supplied from the power board 21 to at least one of the battery BTA, the backlight driving circuit 256, or the mainboard MD.

The battery BTA can supply the DC voltage to any one of the backlight driving circuit 256 or the mainboard MD.

The battery BTA can also be included in the charge and discharge board 630, and also provided separately from the charge and discharge board 630.

When the DC voltage from the AC/DC converter 191 is not supplied to the head 10, the battery BTA can supply the DC voltage to the head 10 through discharging.

When the display 180 includes a liquid crystal panel, the backlight driving circuit 256 can be a circuit for driving a backlight.

For example, the display 180 can include the liquid crystal panel, and a backlight outputting light to the liquid crystal panel. The backlight driving circuit 256 can control a light output of the backlight based on a dimming value.

The mainboard MD can control all operations of the head 10. The mainboard MD can include a signal processing device 170 and a power controller 620.

The display 180 can display an image based on an image signal from the signal processing device 170.

Meanwhile, when the display 180 includes an organic light emitting diode (OLED) display panel, the backlight driving circuit 256 cannot be included in the head 10.

Meanwhile, the head 10 includes a first interface 605 receiving an input signal from an input device 700 and a second interface 610 for wired connection with an external device 1200.

For example, when the input device 700 is a keyboard, the first interface 605 can include a USB terminal for receiving an input signal of the keyboard.

As another example, when the input device 700 is a mouse, the first interface 605 can include a USB terminal for receiving an input signal of the mouse.

As yet another example, when the input device 700 is a remote controller 200, the first interface 605 can include the user input interface 150 of FIG. 2 in order to receive a wireless signal from the remote controller 200.

As still yet another example, when the input device 700 is a game pad, the first interface 605 can include a USB terminal for receiving an input signal from the game pad.

Meanwhile, the second interface 610 can include a USB-C terminal.

Meanwhile, the second interface 610 can be configured to receive an image signal or an audio signal from the external device 1200 which is wiredly connected according to a display mode.

For example, the second interface 610 can be configured to transmit the DC voltage to the external device 1200 in response to receiving the image signal or audio signal from the external device 1200 which is wiredly connected according to the display mode.

As another example, the second interface 610 can be configured to receive the DC voltage from the external device 1200 in response to receiving the image signal or audio signal from the external device 1200 which is wiredly connected according to the display mode.

As yet another example, the second interface 610 can supply the DC voltage to the external device 1200 according to a source mode.

As still yet another example, the second interface 610 can be configured to receive the DC voltage from the external device 1200 according to a sink mode.

Meanwhile, the power controller 620 in the mainboard MD can detect whether the external device 1200 is connected through the second interface 610.

FIG. 6 illustrates an example of an internal block diagram of an image display apparatus according to an embodiment of the present disclosure.

Referring to FIG. 6, the image display apparatus 100 according to an exemplary embodiment of the present disclosure includes a display 180, a signal processing device 170 outputting an image signal to the display 180, a first interface 605 receiving an input signal from an input device 700, and a second interface 610 wiredly connected to an external device 1200.

Meanwhile, the image display apparatus 100 according to an embodiment of the present disclosure further includes a power controller 620 controlling the source mode, the sink mode, or the display mode of the second interface 610, an internal battery BTA, and a charge and discharge board 630 controlling a charge mode or a discharge mode of the internal battery BTA.

Meanwhile, the second interface 610 according to an embodiment of the present disclosure can operate in any one of a sink mode, a source mode, and a display mode.

For example, in the case in which operating in the sink mode, the second interface 610 can be configured to receive a first DC voltage Vm or a first DC current IPHm corresponding to the first DC voltage Vm from the external device 1200.

Meanwhile, when a second DC voltage DC-IN is supplied through a DC voltage input terminal 632, the charge and discharge board 630 can supply a voltage of approximately 13 V to an interface 652 of the mainboard MD.

Meanwhile, in the case in which operating in the source mode, the second interface 610 can be configured to supply a third DC voltage Vn or a third DC current IPHn corresponding to the third DC voltage Vn to the external device 1200.

Meanwhile, in the case in which operating in the display mode, the second interface 610 can be configured to receive an image signal Svd from the external device 1200.

Meanwhile, the second interface 610 can include a USB-C type interface.

For example, the second interface 610 can include a first port PT1 configured to receive the first DC voltage Vm in the sink mode or output the third DC voltage Vn to the outside in the source mode, and a second port PT2 configured to receive voltage information of the external device 1200.

Meanwhile, the first port PT1 can be connected to a VBUS line, and the second port PT2 can be connected to a CC1/2 line.

Meanwhile, the second interface 610 can further include a third port PT3 that is connected to a separate second bus SBU1/2 line in addition to the VBUS line as the first bus.

Meanwhile, the second interface 610 can further include a fourth port PT4 and a fifth port PT5 for receiving an image signal Svd from the external device 1200 or transmitting an image signal to the external device 1200 in the case in which operating in the display mode.

Meanwhile, the fourth port PT4 can be connected to a TX1 /RX1 line, and the fifth port PT5 can be connected to a TX2 /RX2 line.

Meanwhile, the second interface 610 can further include a fourth port PT4 and a fifth port PT5 for receiving an image signal Svd from the external device 1200 or transmitting an image signal to the external device 1200 in the case in which operating in the display mode.

Meanwhile, the fourth port PT4 can be connected to a TX1 /RX1 line, and the fifth port PT5 can be connected to a TX2 /RX2 line.

Meanwhile, the second interface 610 can further include a sixth port PT6 for a USB 2.0 interface.

Meanwhile, the sixth port PT6 can be connected to a USB D+/D−line.

Meanwhile, the charge and discharge board 630 is provided with a DC voltage input terminal 632.

Meanwhile, the charge and discharge board 630 can further include a second interface 634 configured to supply voltage or current to the internal battery BTA in a charging mode of the internal battery BTA and receive voltage or current in a discharging mode of the internal battery BTA, and a switching device 636 configured to perform switching to supply the voltage or current from the second interface 610 to the second interface 634.

Meanwhile, the image display apparatus 100 according to an embodiment of the present disclosure can further include a dc/dc converter 644 electrically connected to the first port PT1.

Meanwhile, the dc/dc converter 644 can be connected between the first port PT1 of the second interface 610 and a switch 647.

Meanwhile, the dc/dc converter 644 can decrease the level of the first DC voltage Vm received through the first port PT1 in the sink mode and supply the decreased level DC voltage 5V_TYPE-C to the power controller 620 via the switch 647.

For example, the dc/dc converter 644 can decrease the level of the first DC voltage Vm of about 5 to 20 V and supply the voltage of about 5 V to the power controller 620. Accordingly, the power controller 620 can be stably operated based on the DC voltage from the external device 1200.

Meanwhile, the switch 647 can also supply a level-converted DC voltage 5V_NORMAL based on the internal battery BTA to the power controller 620 in the case in which the first DC voltage Vm is not supplied through the second interface 610.

Meanwhile, the DC voltage 5V_TYPE-C output from the dc/dc converter 644 can be input to the signal processing device 170.

At this time, the signal processing device 170 can be configured to receive a USB-C_CHG_DET signal related to the sink mode operation based on the DC voltage 5V_TYPE-C.

That is, the signal processing device 170 can determine the sink mode operation in the case in which the level of the USB-C_CHG_DET signal corresponding to the DC voltage 5V_TYPE-C is a high level.

Meanwhile, the power controller 620 is electrically connected to a plurality of ports PT2 to PT5 of the second interface 610 and can be configured to receive signals from the plurality of ports PT2 to PT5 of the second interface 610.

For example, the power controller 620 can be configured to receive voltage information or current information of the external device 1200 through the second port PT2 of the second interface 610.

As another example, the power controller 620 can be configured to receive an image signal Svd and transmit the image signal Svd to the signal processing device 170 or the power controller 620, through the fourth port PT4 or the fifth port PT5 of the second interface 610 in the display mode.

Meanwhile, the power controller 620 can have a plurality of ports for signal transmission or reception with the signal processing device 170.

For example, the power controller 620 can include a VMON port for receiving a TYPE-C_VBUS signal, an MGPIO2 port for transmitting a TYPE-C_CC_DET signal, a GPIO4 port for transmitting an ALT_MODE_NOTICE signal, an I2C_EN/GPIO10 port for transmitting a 5V_USB-C_EN signal, an I2C_INT/GPIO9 port for transmitting a 65W_USB-C_EN signal, an IMON port for transmitting a 100W_USB-C_EN signal, a LOC_PWR_MON port for transmitting a TYPE-C_VBUS_DISCHARGE signal, etc.

Meanwhile, the TYPE-C_VBUS signal can correspond to a signal input to the first port PT1 of the second interface 610 in the source mode.

Meanwhile, the power controller 620 can output a high-level 5V_USB-C_EN signal in the source mode, and a load switch 645 can be turned on based on the 5V_USB-C_EN signal.

Meanwhile, the power controller 620 can determine a first sink mode operation or a second sink mode operation in the sink mode, based on the voltage information or current information of the external device 1200.

For example, the power controller 620 can output a high-level 65W_USB-C_EN signal for the first sink mode operation based on 65W 20V/3.25 A, or output a high-level 100W_USB-C_EN signal for the second sink mode operation based on 100W 20V/5 A, based on the voltage information or current information of the external device 1200.

Meanwhile, the power controller 620 can output a high-Level TYPE-C_VBUS_DISCHARGE signal for discharging TYPE-C_VBUS.

Meanwhile, the signal processing device 170 can further include a converter 642 for converting a display signal or an image signal Svd into an HDMI signal in the display mode between the power controller 620 and the signal processing device 170.

Meanwhile, the signal processing device 170 can output a reset signal RESET_N to reset the converter 642.

Meanwhile, the image display apparatus 100 according to an embodiment of the present disclosure can further include a load switch 645 electrically connected to the first port PT1 of the second interface 610.

Meanwhile, the image display apparatus 100 according to an embodiment of the present disclosure can further include a barrier diode connected between the load switch 645 and the first port PT1 of the second interface 610.

Meanwhile, the load switch 645 is turned off in the sink mode. Accordingly, the barrier diode and the first port PT1 of the second interface 610 are electrically insulated from each other.

Meanwhile, the load switch 645 is turned on in the source mode and can be configured to supply the third DC voltage Vn to the first port PT1 based on the conduction of the barrier diode. Accordingly, in the source mode, the DC voltage can be stably supplied to the external device 1200.

Meanwhile, the second interface 610 can be configured to supply the first DC voltage Vm received through the first port PT1 in the sink mode to the charge and discharge board 630. Accordingly, the internal battery BTA can be easily charged through the sink mode.

Meanwhile, the charge and discharge board 630 can further include a DC voltage input terminal 632, a second interface 634 configured to supply voltage or current to the internal battery BTA in a charging mode of the internal battery BTA and receive voltage or current in a discharging mode of the internal battery BTA, and a switching device 636 configured to perform switching to supply the voltage or current from the second interface 610 to the second interface 634.

Meanwhile, when the second DC voltage DC-IN is supplied from an AC/DC converter 191 through a DC voltage input terminal 632, the charge and discharge board 630 can supply the voltage of approximately 13 V to the interface 652 of the mainboard MD.

Meanwhile, the charge and discharge board 630 can be configured to transmit a high-level power signal POWER_ACD to the switching element 653 in the main board MD in the case in which the second DC voltage DC-IN is supplied through the DC voltage input terminal 632.

Meanwhile, the main board MD can further include a signal receiving device 656 including a first diode to which a 65W_USB-C_EN signal is applied and a second diode to which a 100W_USB-C_EN signal is applied, a second switching element 658 connected to the signal receiving device 656, and a switching element 653 having one end connected between the signal receiving device 656 and the second switching element 658.

For example, in the case in which the second DC voltage DC-IN is supplied through the DC voltage input terminal 632, a high-level power signal POWER_ACD is input to the switching element 653, and the switching element 653 is turned off. Accordingly, the second switching element 658 is also turned off.

Accordingly, a 20V_VBUS_ON/OFF signal output from the second switching element 658 becomes a low level, and the switching element 636 in the charge and discharge board 630 is turned off based on the low-level 20V_VBUS_ON/OFF signal.

Accordingly, in the case in which the second DC voltage DC-IN is supplied through the DC voltage input terminal 632, the supply of the first DC voltage Vm or the first DC current IPHm to the charge and discharge board 630 is stopped due to the turn-off of the switching element 636.

As another example, in the case in which the second DC voltage DC-IN is supplied through the DC voltage input terminal 632, a low-level power signal POWER_ACD is input to the switching element 653, and the switching element 653 is turned on.

Meanwhile, depending on the operation of the sink mode, if either the 65W_USB-C_EN signal or the 100W_USB-C_EN signal is at a high level, the signal receiving device 656 is conducted and the second switching element 658 is also turned on.

Accordingly, the 20V_VBUS_ON/OFF signal output from the second switching element 658 becomes a high level, and the switching element 636 in the charge and discharge board 630 is turned on based on the high-level 20V_VBUS_ON/OFF signal.

Accordingly, in the case in which the second DC voltage DC-IN is not supplied through the DC voltage input terminal 632, the first DC voltage Vm or the first DC current IPHm is supplied to the charge and discharge board 630 due to the turn-on of the switching device 636. Accordingly, it is possible to stably charge the internal battery BTA.

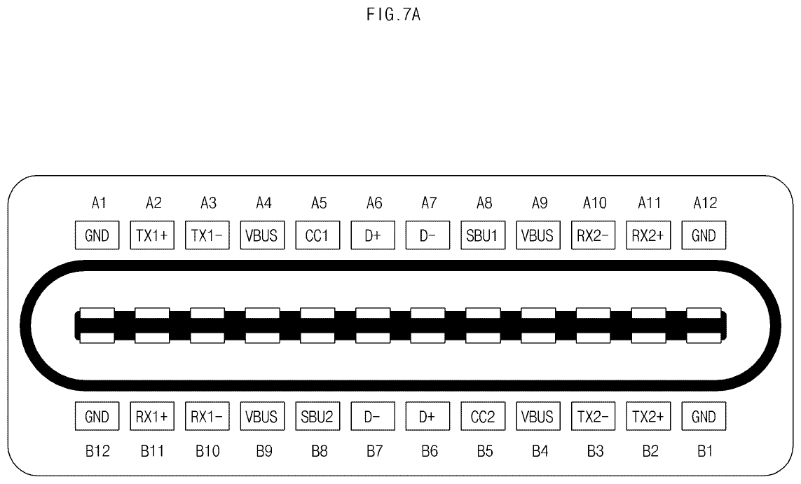

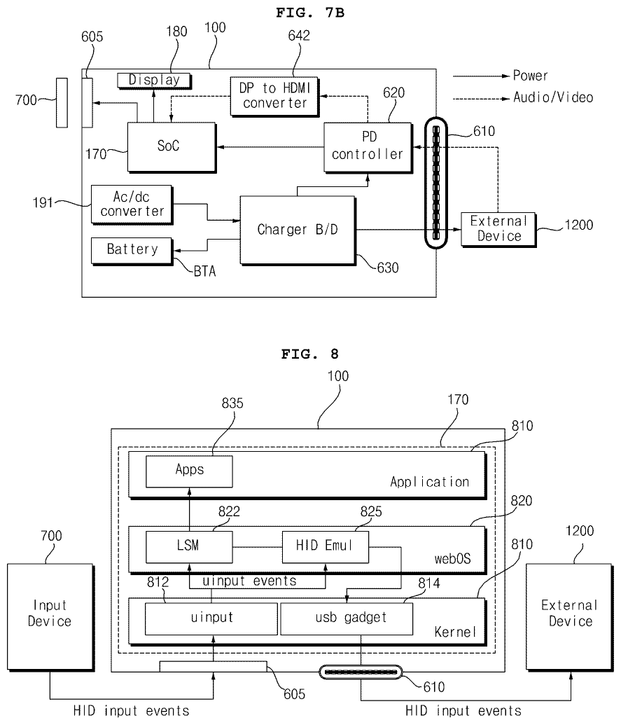

FIGS. 7A and 7B are diagrams referred to for description of FIG. 6.

FIG. 7A illustrates an example of a port of the second interface.

Referring to FIG. 7A, the second interface 610 can include ground ports A1, A12, B1, and B12, TX ports A2, A3, B2, and B3, VBUS ports A4, A9, B4, and B9, CC ports A5 and B5, D ports A6, A7, B6, and B7, SBU ports A8 and B8, and RX ports A10, A11, B10, and B11.

The VBUS ports A4, A9, B4, and B9 can correspond to the first port PT1 of FIG. 6, the CC ports A5 and B5 can correspond to the second port PT2 of FIG. 6, the SBU ports A8 and B8 can correspond to the third port PT3 of FIG. 6, the TX ports A2, A3 B2, and B3 and the RX ports A10, A11, B10, and B11 can correspond to the fourth port PT4 or the fifth port PT5 of FIG. 6, and the D ports A6, A7, B6, and B7 can correspond to the sixth port PT6 of FIG. 6.

As an example, the DC voltage can be received from the external device 1200, or the DC voltage can be supplied, through the VBUS ports A4, A9, B4, and B9 or the CC ports A5 and B5.

As another example, the image signal can be received from the external device 1200 or the image signal can be transmitted to the external device 1200, through the TX ports A2, A3, B2, and B3 or the RX ports A10, A11, B10, and B11.

FIG. 7B illustrates a schematic example of the internal block diagram of the image display apparatus of FIG. 6.

Referring to FIG. 7B, the image display apparatus 100 according to an exemplary embodiment of the present disclosure includes a display 180, a signal processing device 170 outputting an image signal to the display 180, a first interface 605 receiving an input signal from an input device 700, and a second interface 610 wiredly connected to an external device 1200.

Meanwhile, the image display apparatus 100 according to an embodiment of the present disclosure can further include the AC/DC converter 191 which can be configured to convert an AC voltage into a DC voltage, the battery BTA storing the DC voltage, the charge and discharge board 630 controlling a charge or discharge operation based on the DC voltage from the battery BTA or the AC/DC converter 191, and the power controller 620 controlling the source mode, the sink mode, or the display mode of the second interface 610.

Meanwhile, the image display apparatus 100 according to an embodiment of the present disclosure can further include the converter 642 for converting the display signal or the image signal Svd received through the second interface 610.

For example, the converter 642 can be configured to convert the display signal or the image signal Svd received through the second interface 610 into the HDMI signal.

The second interface 620 can be configured to transmit, to the power controller 620, the audio signal or the image signal received from the external device 1200.

Meanwhile, the power controller 620 can be configured to transmit, to the converter 642, the audio signal or the image signal received from the external device 1200.

Meanwhile, the converter 642 can be configured to convert the audio signal or the image signal received from the external device 1200, and transmit the converted audio signal or image signal to the signal processing device 170.

Meanwhile, the signal processing device 170 can control the converted audio signal or image signal to be received or a sound to be output through an audio output unit 185, or control an image to be displayed on the display 180.

Meanwhile, the charge and discharge board 630 can be configured to receive the DC voltage from the battery BTA or the AC/DC converter 191, and transmit the DC voltage to the power controller 620.

Meanwhile, the power controller 620 can be configured to transmit the DC voltage to the signal processing device 170.

Meanwhile, when the interface 610 is in the source mode, the power controller 620 can be configured to transmit the DC voltage to the external device 1200 through the second interface 610.

Meanwhile, the second interface 610 can be configured to transmit the DC voltage to the external device 1200 in response to receiving the image signal or the audio signal.

Meanwhile, when the interface 610 is in the sink mode, the power controller 620 can be configured to receive the DC voltage from the external device 1200 through the second interface 610.

Meanwhile, the second interface 610 can be configured to receive the DC voltage from the external device 1200 in response to receiving the image signal or the audio signal.

FIG. 8 illustrates an example of an internal block diagram of the signal processing device of FIG. 6.

Referring to FIG. 8, the signal processing device 170 can be configured to execute an operating system 820, execute an application 825 on the operating system 820, execute an emulator 825 operating based on an input signal from a first interface 605, and transmit a signal corresponding to the input signal to the application 825 or the external device 1200.

Accordingly, the application 825 can be controlled or the external device 1200 can be controlled based on the input signal from the input device 700. In particular, the application 825 can be controlled or the external device 1200 can be controlled based on various input signals.

Meanwhile, the signal processing device 170 according to another embodiment of the present disclosure can be configured to execute the operating system 820, execute the application 825 on the operating system 820, execute an emulator 825 converting the input signal from the first interface 605 into a data packet, and the second interface 610 transmits the converted packet to the external device 1200. Accordingly, the external device 1200 can be controlled based on the input signal from the input device 700.

Meanwhile, the signal processing device 170 can be configured to execute a kernel 810, execute the operating system 820 on the kernel 810, and execute the application 825 on the operating system 820.

For example, the signal processing device 170 can be configured to execute the kernel 810, execute the operating system 820 on the kernel 810, execute an application layer 830 on the operating system 820, and execute the application 825 in the application layer 830.

For example, the application 825 can be a broadcast application for displaying a broadcast image, a home screen application for displaying a home screen, or a content application for displaying a specific content.

Meanwhile, the emulator 825 can be configured to receive the input signal from the first interface 605 through the kernel 810 or transmit the signal corresponding to the input signal to the external device 1200 through the kernel 810.

In particular, the emulator 825 can be configured to receive the input signal from the first interface 605 through an input interface 812 in the kernel 810 or transmit the signal corresponding to the input signal to the external device 1200 through a USB gadget interface 814 in the kernel 810.

Accordingly, the application 825 can be controlled or the external device 1200 can be controlled based on the input signal from the input device 700.

Meanwhile, the signal processing device 170 can be further configured to execute a manager 820 configured to determine whether to transmit the signal corresponding to the input signal to the application 825 or the external device 1200 based on the signal from the emulator 825.

Meanwhile, the manger 820 checks an operation state of the emulator 825 to determine whether to control the application 825.

For example, when the emulator 825 operates, the manger 820 can determine to transmit the input signal from the first interface 605 to the external device 1200, or to control the external device 1200.

As another example, the manger 820 can determine to transmit the input signal from the first interface 605 to control external device 1200, or to control the external device 1200, when displaying the external input image based on the image signal from the external device 1200.

As yet another example, the manger 820 can determine to transmit the input signal from the first interface 605 to the external device 1200, or to control the external device 1200, when there is a control request of the external device 1200.

As still yet another example, when the emulator 825 does not operate, the manger 820 can determine to transmit the input signal from the first interface 605 to the application 825, or to control the application 825.

Meanwhile, when controlling the external device 1200 is required, the emulator 825 in the signal processing device 170 can generate a virtual USB device through the USB gadget interface 814 in the kernel 810.

Accordingly, a role of the second interface 610 is changed to a USB device, and the external device 1200 can recognize the image display apparatus 100 as the USB device.

Meanwhile, when controlling the external device 1200 is required, the emulator 825 in the signal processing device 170 can be configured to convert the input signal from the first interface 605 into a data packet, and transmit the converted packet to the external device 1200. Accordingly, the application 825 can be controlled or the external device 1200 can be controlled based on the input signal from the input device 700.

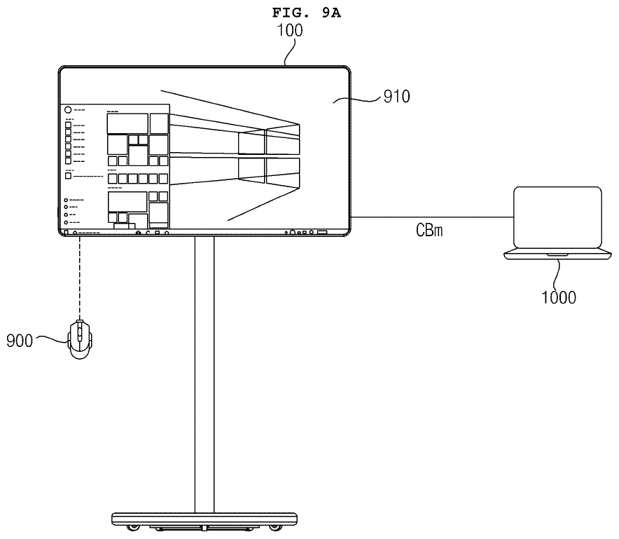

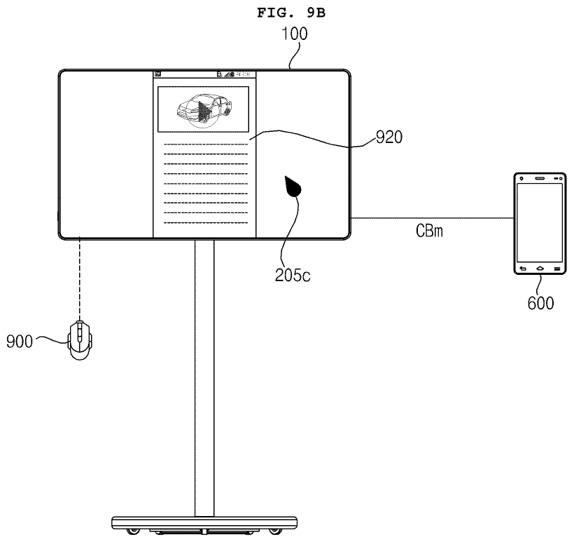

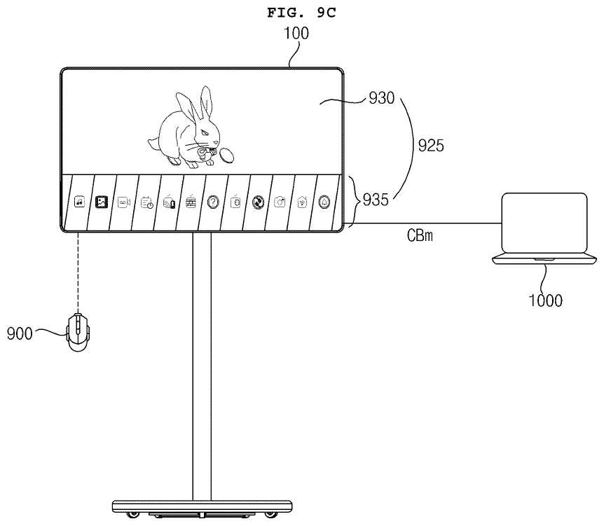

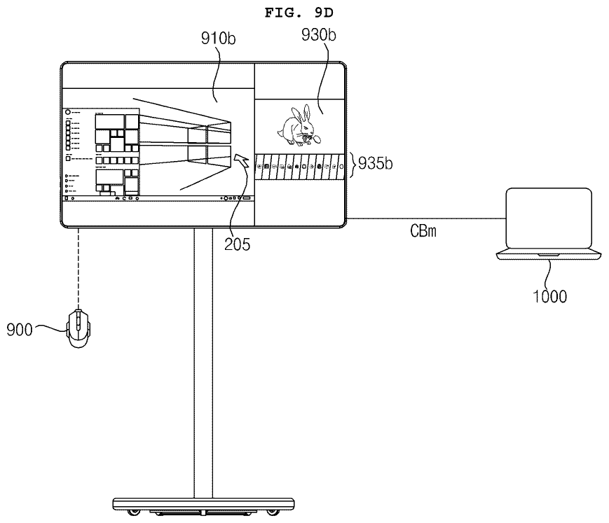

FIGS. 9A to 15D are diagrams referred to for description of an operation of FIG. 8.

FIGS. 9A to 9D are diagrams for describing various operations of the image display apparatus for controlling the application or controlling the external device.

First, FIG. 9A illustrates an example of the operation of the image display apparatus when controlling a notebook 1000 is required when the external device is the notebook.

Referring to FIG. 9A, the image display apparatus 100 can be wiredly connected to the notebook 1000 which is one example of the external device 1200 through a cable CBm, and when controlling the notebook 1000 is required, the signal processing device 170 can be configured to set first data for controlling the notebook 1000 to a first value and set second data for controlling the application 825 to a second value.

For example, when controlling the notebook 1000 is required, the manager 820 in the signal processing device 170 can be configured to set enableExternalDeviceControl for controlling the notebook 1000 to ‘1’ corresponding to true and set enableForceWebOSAppControl for controlling the application 825 to ‘0’ corresponding to false.

Meanwhile, the signal processing device 170 can be configured to receive an image signal from the notebook 1000 and display a notebook screen 910 corresponding to the received image signal on the display 180.

Next, FIG. 9B illustrates an example of the operation of the image display apparatus when controlling a mobile terminal 600 is required when the external device is the mobile terminal.

Referring to FIG. 9B, the image display apparatus 100 can be wiredly connected to the mobile terminal 600 which is one example of the external device 1200 through the cable CBm, and when controlling the mobile terminal 600 is required, the signal processing device 170 can be configured to set first data for controlling the mobile terminal 600 to a first value and set second data for controlling the application 825 to a second value.

For example, when controlling the mobile terminal 600 is required, the manager 820 in the signal processing device 170 can be configured to set enableExternalDeviceControl for controlling the mobile terminal 600 to ‘1’ corresponding to true and set enableForceWebOSAppControl for controlling the application 825 to ‘0’ corresponding to false.

Meanwhile, the signal processing device 170 can control to receive the image signal from the mobile terminal 600 and display a mobile terminal screen 920 corresponding to the received image signal on the display 180.

FIG. 9C illustrates an example of an operation of the image display apparatus in response to control of the application being required while the notebook 100 is connected.

Referring to FIG. 9C, when controlling the application 825 is required while the image display apparatus 100 is wiredly connected to the notebook 1000 which is one example of the external device 1200 through the cable CBm, the signal processing device 170 can be configured to set the first data for controlling the notebook 1000 to a third value and set the second data for controlling the application 825 to a fourth value.

For example, when controlling the application 825 is required, the manager 820 in the signal processing device 170 can be configured to set enableExternalDeviceControl for controlling the notebook 1000 to ‘0’ corresponding to false and set enableForceWebOSAppControl for controlling the application 825 to ‘0’ corresponding to don'care or false.

Accordingly, the signal processing device 170 can control the application 825 based on the input signal from the input device 700.

FIG. 9D illustrates an example of an operation of the image display apparatus when controlling the notebook 1000 and controlling the application 825 are required.

Referring to FIG. 9D, the image display apparatus 100 can be wiredly connected to the notebook 1000 which is one example of the external device 1200 through the cable CBm, and when controlling the application 825 and controlling the notebook 1000 are required, the signal processing device 170 can be configured to set the first data for controlling the notebook 1000 to a first value and set the second data for controlling the application 825 to a fifth value.

For example, when controlling the notebook 1000 and controlling the application 825 are required, the manager 820 in the signal processing device 170 can be configured to set enableExternalDeviceControl for controlling the mobile terminal 600 to ‘1’ corresponding to true and set enableForceWebOSAppControl for controlling the application 825 to ‘1’ corresponding to true.

Meanwhile, the signal processing device 170 can be configured to receive the image signal from the notebook 1000 and display a notebook screen 910b corresponding to the received image signal and a home screen 930b of the image display apparatus 100 on the display 180 together.

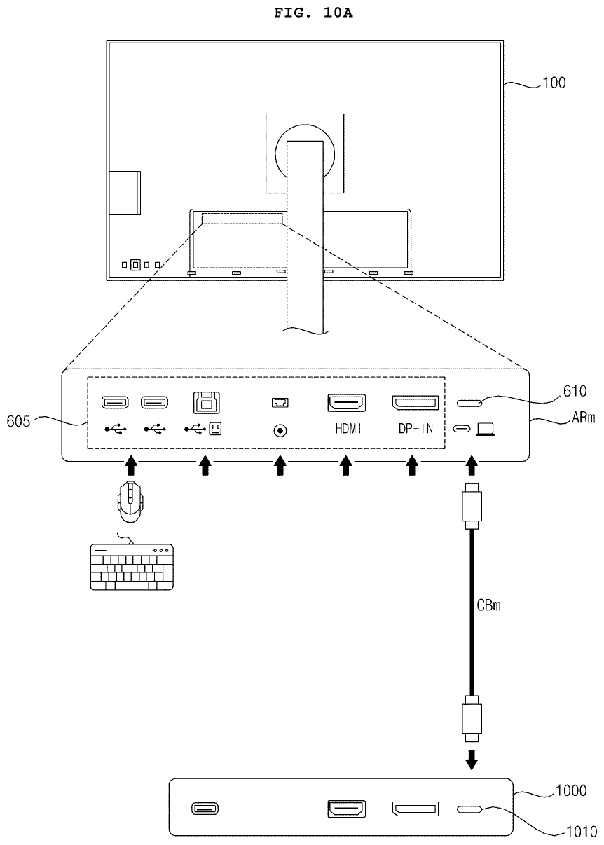

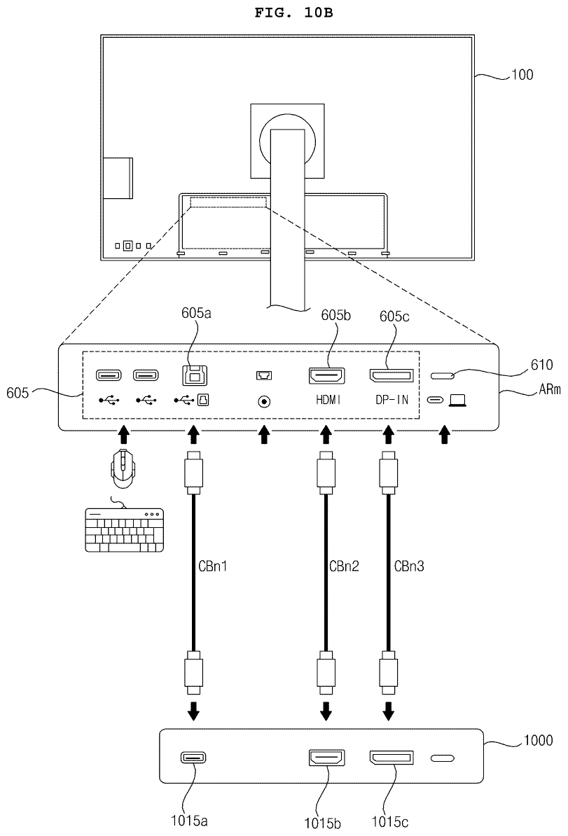

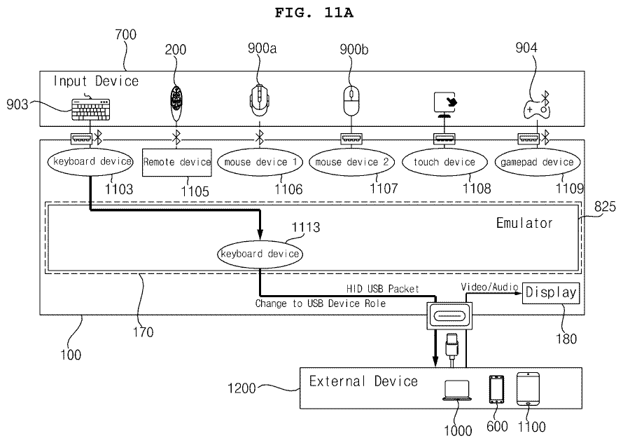

FIG. 10A illustrates an example of a connection of the notebook which is one example of the external device and the image display apparatus.

Referring to FIG. 10A, the first interface 605 and the second interface 610 can be disposed on a part of a backside of the image display apparatus 100.

The first interface 605 can include a USB-B terminal, a LAN port, an optical digital input terminal, an HDMI terminal a DP-in terminal, etc.

Meanwhile, the second interface 610 can include a USB-C terminal, etc.

For example, the notebook 1000 which is one example of the external device can be wiredly connected to the second interface 610 of the image display apparatus 100 through the cable CBm.

Specifically, the USB-C terminal 1010 of the notebook 1000 can be wiredly connected to the USB-C terminal which is the second interface 610 of the image display apparatus 100 through the cable CBm.

The second interface 610 of the image display apparatus 100 can be configured to receive the image signal from the notebook 1000, or receive the DC voltage, or supply the DC voltage to the notebook 1000.

Meanwhile, a mouse, a keyboard, etc., can be connected through the USB-B terminal in the first interface 605.

FIG. 10B illustrates another example of a connection of the notebook which is one example of the external device and the image display apparatus.

Referring to FIG. 10B, the notebook 1000 which is one example of the external device can be wiredly connected to the first interface 605 of the image display apparatus 100 through a first cable CBn1, a second cable CBn2, and a third cable CBn3.

In particular, the notebook 1000 which is one example of the external device can be wiredly connected to the USB-B terminal, the HDMI terminal, and the DP-in terminal in the first interface 605 through the first cable CBn1, the second cable CBn2, and the third cable CBn3.

The first interface 605 of the image display apparatus 100 can be configured to receive the image signal from the notebook 1000, or receive the DC voltage, or supply the DC voltage to the notebook 1000, through the USB-B terminal, the HDMI terminal, and the DP-in terminal..

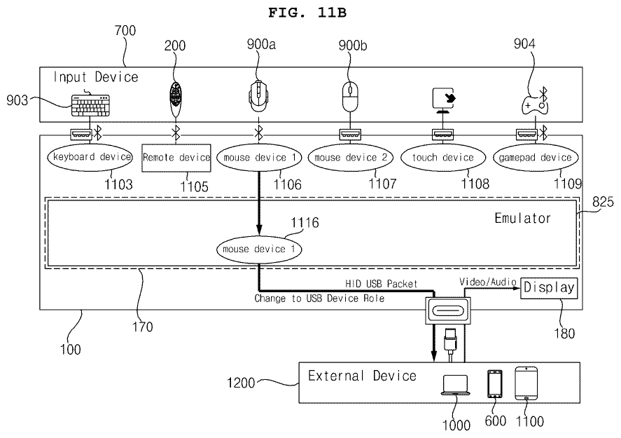

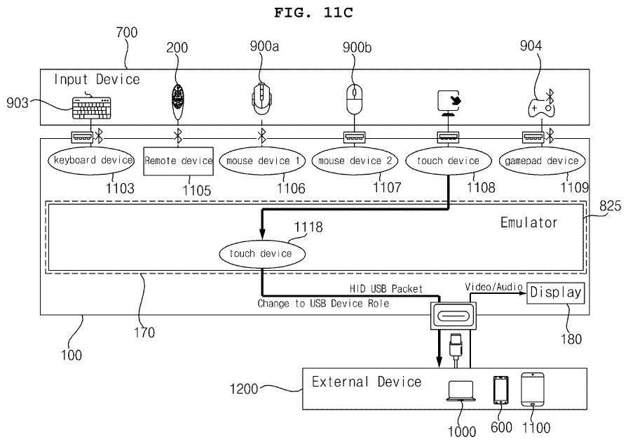

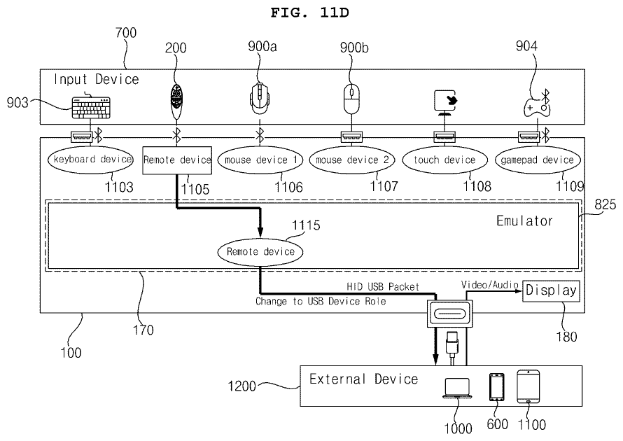

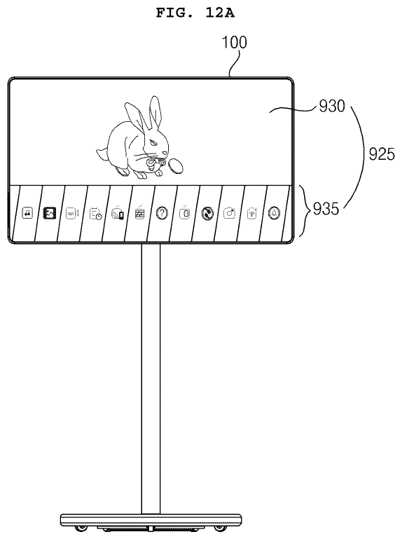

FIG. 11A illustrates a case where the keyboard among the input devices is connected to the image display apparatus.

Referring to FIG. 11A, the input device connected to the first interface 605 of the image display apparatus 100 can be a keyboard 903, a remote controller 200, a mouse 900a, a second mouse 900b, a game pad 904, etc.

Meanwhile, the image display apparatus 100 can also receive a touch input into the display 180.

When the keyboard 903 among the input devices is connected to the first interface 605 of the image display apparatus 100, the first interface 605 or the signal processing device 170 receives an input signal of the keyboard 903 through a keyboard device driver 1103.

Meanwhile, the emulator 825 in the signal processing device 170 can be configured to convert the input signal of the keyboard 903 into a data packet, and the second interface 610 can be configured to transmit the converted packet to the external device 1200.

In particular,, the emulator 825 in the signal processing device 170 can be configured to execute a virtual keyboard device driver 1113, and transmit a data packet converted through the virtual keyboard device driver 1113 to the external device 1200 through the second interface 610.

Meanwhile, the external device 1200 can recognize the image display apparatus 100 as the USB device through the virtual keyboard device driver 1113.

At this time, the external device 1200 can be any one of the notebook 1000, the mobile terminal 600, or a tablet 1100.

FIG. 11B illustrates a case where the mouse among the input devices is connected to the image display apparatus.

Referring to FIG. 11B, when the mouse 900a among the input devices is connected to the first interface 605 of the image display apparatus 100, the first interface 605 or the signal processing device 170 receives an input signal of the mouse 900a through a mouse device driver 1106.

Meanwhile, the emulator 825 in the signal processing device 170 can be configured to convert the input signal of the mouse 900a into a data packet, and the second interface 610 can be configured to transmit the converted packet to the external device 1200.

In particular, the emulator 825 in the signal processing device 170 can be configured to execute the virtual keyboard device driver 1116, and transmit the data packet converted through the virtual mouse device driver 1116 to the external device 1200 through the second interface 610.

Meanwhile, the external device 1200 can recognize the image display apparatus 100 as the USB device through the virtual mouse device driver 1116.

At this time, the external device 1200 can be any one of the notebook 1000, the mobile terminal 600, or the tablet 1100.

FIG. 11C illustrates a case where the touch input signal of the display 180 is received.

Referring to FIG. 11C, when the touch input signal of the display 180 is received, the first interface 605 or the signal processing device 170 can be configured to receive the touch input signal of the display 180 through a touch driver 1108.

Meanwhile, the emulator 825 in the signal processing device 170 can be configured to convert the touch input signal of the display 180 into a data packet, and the second interface 610 can be configured to transmit the converted packet to the external device 1200.

In particular, the emulator 825 in the signal processing device 170 can be configured to execute a virtual touch device driver 1118, and transmit a data packet converted through the virtual touch device driver 1118 to the external device 1200 through the second interface 610.

Meanwhile, the external device 1200 can recognize the image display apparatus 100 as the USB device through the virtual touch device driver 1118.

At this time, the external device 1200 can be any one of the notebook 1000, the mobile terminal 600, or the tablet 1100.

FIG. 11D illustrates a case where the remote controller among the input devices is connected to the image display apparatus.

Referring to FIG. 11D, when the remote controller 200 among the input devices is connected to the first interface 605 of the image display apparatus 100, the first interface 605 or the signal processing device 170 receives an input signal of the remote controller 200 through a remote controller device driver 1105.

Meanwhile, the emulator 825 in the signal processing device 170 can be configured to convert an input signal of the remote controller 200 into a data packet, and the second interface 610 can be configured to transmit the converted packet to the external device 1200.

In particular, the emulator 825 in the signal processing device 170 can be configured to execute a virtual remote controller device driver 1115, and transmit a data packet converted through the virtual remote controller device driver 1115 to the external device 1200 through the second interface 610.

Meanwhile, the external device 1200 can recognize the image display apparatus 100 as the USB device through the virtual remote controller device driver 1115.

At this time, the external device 1200 can be any one of the notebook 1000, the mobile terminal 600, or the tablet 1100.

Meanwhile, unlike FIG. 11D, when the game pad 904 among the input devices is connected to the first interface 605 of the image display apparatus 100, the first interface 605 or the signal processing device 170 receives an input signal of the game pad 904 through a game pad device driver 1109.

Meanwhile, the emulator 825 in the signal processing device 170 can be configured to convert the input signal of the game pad 904 into a data packet, and the second interface 610 can be configured to transmit the converted packet to the external device 1200.

In particular, the emulator 825 in the signal processing device 170 can be configured to execute a virtual game pad device driver (not illustrated), and transmit a data packet converted through the virtual game pad device driver (not illustrated) to the external device 1200 through the second interface 610.

Meanwhile, the external device 1200 can recognize the image display apparatus 100 as the USB device through the virtual game pad device driver (not illustrated).

Meanwhile, as illustrated in FIGS. 11A to 11D, when controlling the external device 1200 is required while input signals from various inputs devices are received or the touch input of the display is received, the signal processing device 170 can be configured to convert the input signal into a data packet, and the second interface 610 can be configured to transmit the converted packet to the external device 1200 and receive an image signal or an audio signal from the external device 1200.

In particular, the signal processing device 170 can be configured to display an image corresponding to the image signal received through the second interface 610 on the display 180.

Meanwhile, the second interface 610 can be configured to transmit the DC voltage to the external device 1200 in response to receiving the image signal or the audio signal.

That is, according to the display mode, the second interface 610 can be configured to operate in a power source mode and transmit the DC voltage to the external device 1200 while receiving the image signal or the audio signal.

Alternatively, the second interface 610 can be configured to receive the DC voltage from the external device 1200 in response to receiving the image signal or the audio signal.

That is, according to the display mode, the second interface 610 can be configured to operate in a power sink mode and receive the DC voltage from the external device 1200 while receiving the image signal or the audio signal.

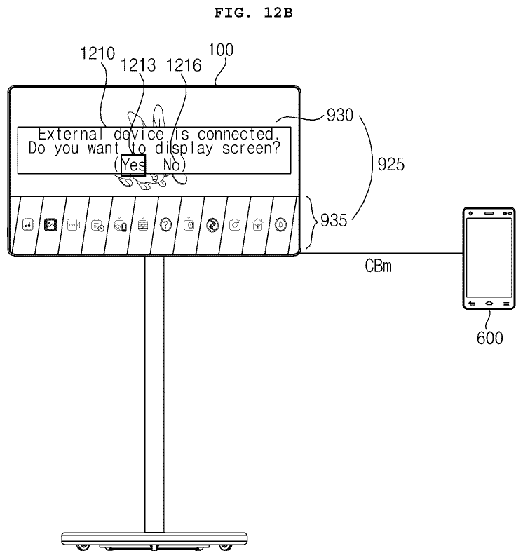

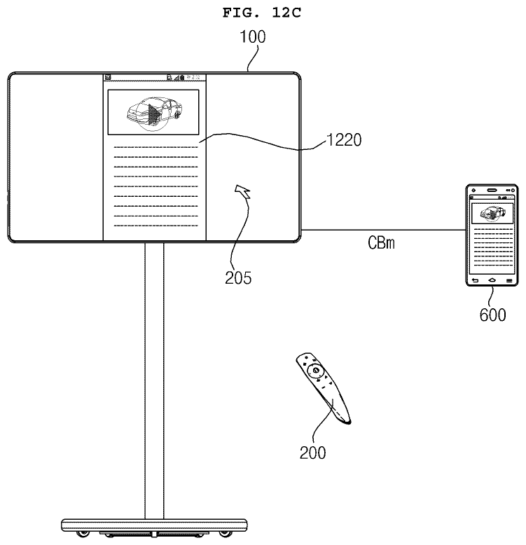

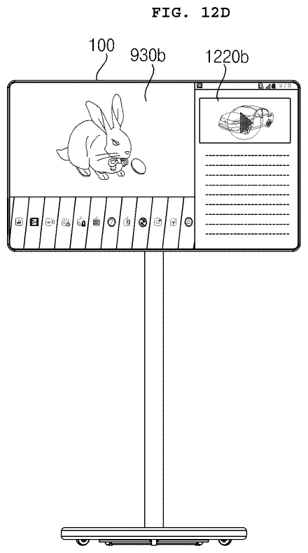

FIG. 12A illustrates that the home screen is displayed in the image display apparatus.

Referring to FIG. 12A, the signal processing device 170 in the image display apparatus 100 can be configured to display the home screen 925.

For example, the signal processing device 170 can be configured to display the home screen 925 based on a power on input or a home screen display input.

Meanwhile, the home screen 925 can include a broadcast image 930 and an application list 935, but is not limited thereto, and can be variously modified.

At this time, the broadcast image 930 can be an image corresponding to execution of a broadcast application.

Meanwhile, when the input signal is received from the input device 700 while displaying the home screen 925, the signal processing device 170 can be configured to perform a channel change or a volume change of the broadcast image 930, or a predetermined item selection in the application list 935.

That is, the signal processing device 170 can be configured to control an executing application when the input signal is received from the input device 700 while displaying the home screen 925.

FIG. 12B illustrates that the mobile terminal 600 which is one example of the external device is wiredly connected to the image display apparatus.

Referring to FIG. 12B, while displaying the home screen 925, the mobile terminal 600 which is one example of the external device can be wiredly connected to the second interface 610 through the cable CBm.

When the mobile terminal 600 which is one example of the external device is wiredly connected to the second interface 610 while displaying the home screen 925, the signal processing device 170 can be configured to display an object 1210 indicating whether to display an image from the external device.

The object 1210 can include an image display item 1213 from the external device, and a display prohibition item 1216 as illustrated in FIG. 12B.

Meanwhile, when the image display item 1213 is selected based on the input signal from the input device 700, the signal processing device 170 can be configured to display an external input image corresponding to the image signal received through the second interface 610.

For example, when a remote control signal from the remote controller 200 is input, the signal processing device 170 can be configured to transmit the data packet converted through the virtual remote controller device driver 1115 to the mobile terminal 600 through the second interface 610 as illustrated in FIG. 11D.

In addition, the mobile terminal 600 which is one example of the external device can be configured to transmit an image signal through the second interface 610.

Meanwhile, the signal processing device 170 can be configured to display the external input image alone as illustrated in FIG. 12C or can be configured to display a home screen image and the external input image together as illustrated in FIG. 12D, based on the image signal received from the mobile terminal 600.

FIG. 12C illustrates that an external input image 1220 from the mobile terminal 600 is displayed alone in the image display apparatus 100.

Referring to FIG. 12C, the signal processing device 170 in the image display apparatus 100 can be configured to receive the image signal from the wiredly connected mobile terminal 600 and display the external input image 1220 corresponding to the received image signal.

Meanwhile, when the remote control signal from the remote controller 200 is input while displaying the external input image 1220, the signal processing device 170 can be configured to transmit the data packet converted through the virtual remote controller device driver 1115 to the mobile terminal 600 through the second interface 610.

FIG. 12D illustrates that the external input image 1220 and the home screen image 930b from the mobile terminal 600 are displayed together in the image display apparatus 100.

Referring to FIG. 12D, the signal processing device 170 can be configured to display a first image corresponding to the image signal received through the second interface 610 and a second image corresponding to the application 825 together.

That is, the signal processing device 170 in the image display apparatus 100 can be configured to receive the image signal from the wiredly connected mobile terminal 600, and the external input image 1220b corresponding to the received image signal, and display the home screen image 930b corresponding to the application 825 together.

Meanwhile, the signal processing device 170 can be configured to perform an input control for any one of the first image and the second image based on an event by the input signal.

For example, when a pointing signal from the remote controller 200 is located in a first area corresponding to the home screen image 930b while displaying the external input image 1220b and the home screen image 930b, the signal processing device 170 in the image display apparatus 100 can control the home screen image 930b or the application 825 to be controlled.

As another example, when the pointing signal from the remote controller 200 is located in a second area corresponding to the external input image 1220b while displaying the external input image 1220b and the home screen image 930b, the signal processing device 170 in the image display apparatus 100 can control the external input image 1220b or the mobile terminal 600 to be controlled.

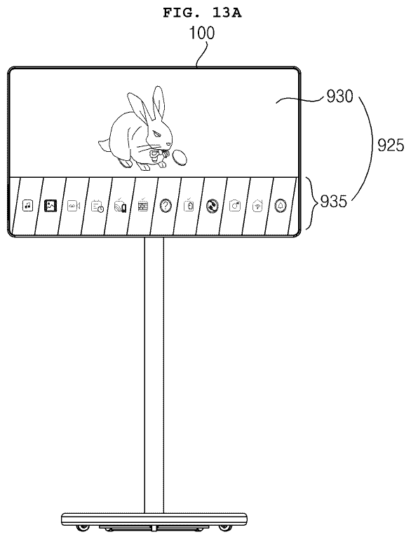

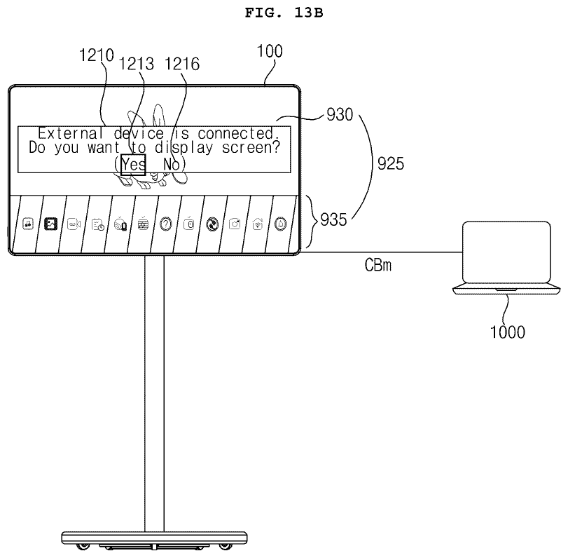

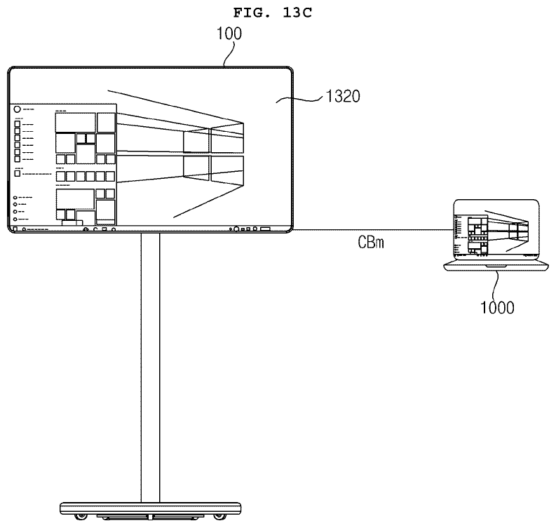

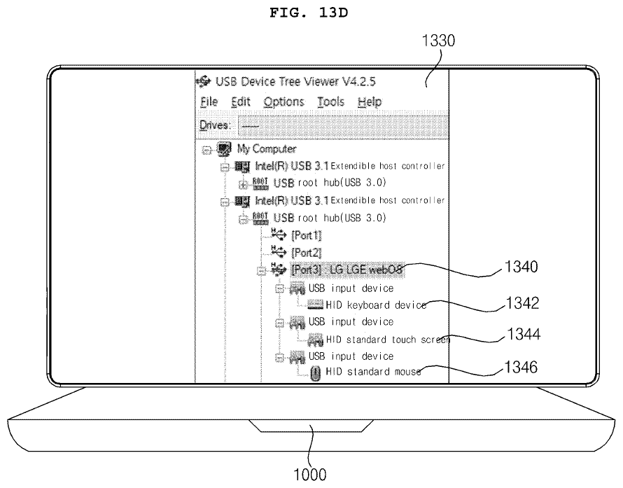

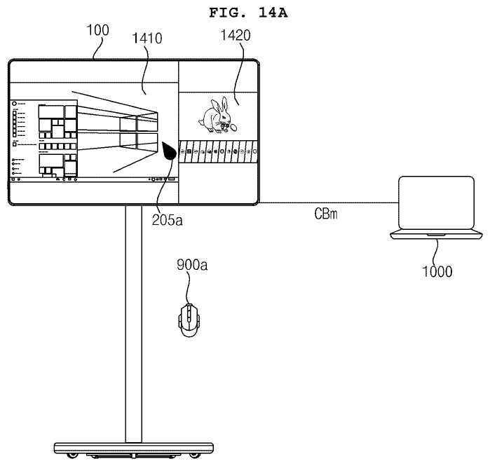

FIG. 13A illustrates that the home screen is displayed in the image display apparatus.

Referring to FIG. 13A, the signal processing device 170 in the image display apparatus 100 can control to display the home screen 925.

Meanwhile, when the input signal is received from the input device 700 while displaying the home screen 925, the signal processing device 170 can control a channel change or a volume change of the broadcast image 930, or a predetermined item selection in the application list 935 to be performed.

FIG. 13B illustrates that the notebook 1000 which is one example of the external device is wiredly connected to the image display apparatus.

Referring to FIG. 13B, while displaying the home screen 925, the notebook 1000 which is one example of the external device can be wiredly connected to the second interface 610 through the cable CBm.

When the notebook 1000 which is one example of the external device is wiredly connected to the second interface 610 while displaying the home screen 925, the signal processing device 170 can control an object 1210 indicating whether to display an image from the external device to be displayed.

The object 1210 can include an image display item 1213 from the external device, and a display prohibition item 1216 as illustrated in FIG. 13B.

Meanwhile, when the image display item 1213 is selected based on the input signal from the input device 700, the signal processing device 170 can be configured to display an external input image corresponding to the image signal received through the second interface 610.

For example, when a remote control signal from the remote controller 200 is input, the signal processing device 170 can be configured to transmit the data packet converted through the virtual remote controller device driver 1115 to the notebook 1000 through the second interface 610.

In addition, the notebook 1000 which is one example of the external device can be configured to transmit an image signal through the second interface 610.

Meanwhile, the signal processing device 170 can be configured to display the external input image alone or can be display a home screen image and the external input image together as illustrated in FIG. 13C, based on the image signal received from the notebook 1000.

FIG. 13C illustrates that an external input image 1320 from the notebook 1000 is displayed alone in the image display apparatus 100.

Referring to FIG. 13C, the signal processing device 170 in the image display apparatus 100 can be configured to receive the image signal from the wiredly connected notebook 1000 and display the external input image 1320 corresponding to the received image signal.

Meanwhile, when the remote control signal from the remote controller 200 is input while displaying the external input image 1320, the signal processing device 170 can be configured to transmit the data packet converted through the virtual remote controller device driver 1115 to the notebook 1000 through the second interface 610.

FIG. 13D illustrates an example of a setting screen 1330 of the notebook 1000 which is one example of the external device.

Referring to FIG. 13D, the setting screen 1330 of the notebook 1000 can include an item related to the wiredly connected image display apparatus 100, etc.

For example, when a role of the second interface 610 of the image display apparatus 100 is changed to the USB device, the notebook 1000 can recognize the image display apparatus 100 as the USB device.

Specifically, the notebook 1000 can recognize the image display apparatus 100 as a USB device 1340 based on a web operating system.

Meanwhile, in FIG. 13D, it is illustrated that each of a keyboard device item 1342, a touch screen item 1344, and a mouse device item 1346 is included in the USB device 1340.

Meanwhile, when the keyboard 903 is connected to the first interface 605 of the image display apparatus 100, the emulator 825 in the signal processing device 170 can be configured to execute the virtual keyboard device driver 1113.

In response thereto, the notebook 1000 can recognize the keyboard device item 1342 as an example of the input device of the image display apparatus 100 based on the virtual keyboard device driver 1113 of the image display apparatus 100.

Meanwhile, when there is the touch input of the display 180 of the image display apparatus 100, the emulator 825 in the signal processing device 170 can be configured to execute the virtual touch device driver 1118.

In response thereto, the notebook 1000 can recognize the touch screen item 1344 as an example of the input device of the image display apparatus 100 based on the virtual touch device driver 1118 of the image display apparatus 100.

Meanwhile, when the mouse 900a is connected to the first interface 605 of the image display apparatus 100, the emulator 825 in the signal processing device 170 can be configured to execute the virtual mouse device driver 1116.

In response thereto, the notebook 1000 can recognize the mouse device item 1346 as an example of the input device of the image display apparatus 100 based on the virtual mouse device driver 1116 of the image display apparatus 100.

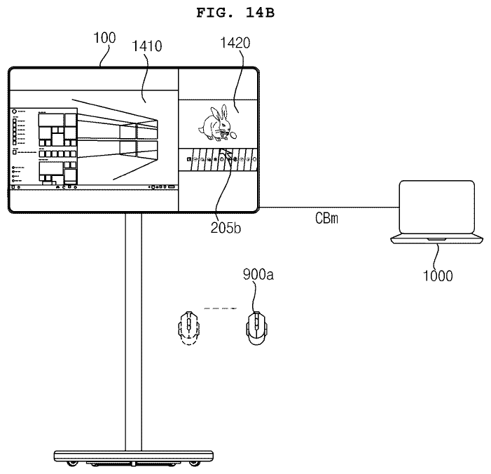

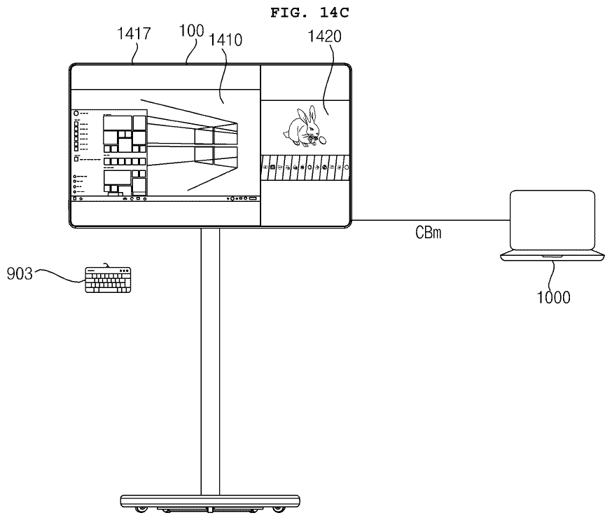

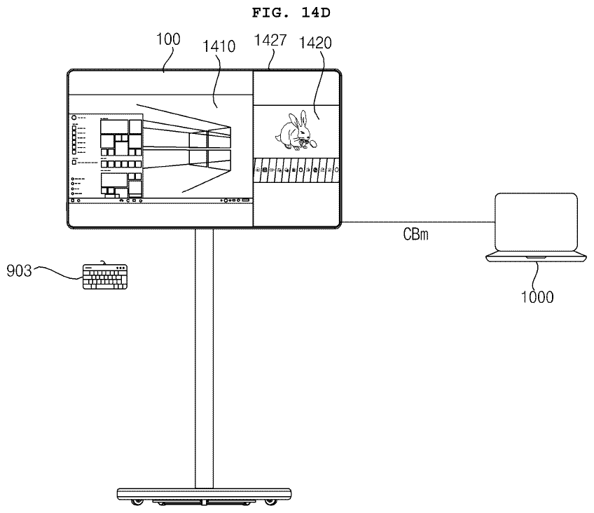

FIG. 14A illustrates that a pointing signal of the mouse 900a is located in an external input image 1410 while displaying the external input image 1410 and the home screen image 1420.

Referring to FIG. 14A, when the keyboard 900a among the input devices is connected to the first interface 605 of the image display apparatus 100, the first interface 605 or the signal processing device 170 receives an input signal of the mouse 900a through a mouse device driver 1106.

Meanwhile, when the pointing signal of the mouse 900a is located in the external input image 1410, the emulator 825 in the signal processing device 170 can be configured to convert an input signal of the mouse 900a into a data packet, and the second interface 610 can be configured to transmit the converted packet to the notebook 1000. Accordingly, the signal processing device 170 can control the notebook 1000 which is the external device.

Meanwhile, when the point signal of the mouse 900a is located in the external input image 1410, the signal processing device 170 can be configured to display a shape of a pointer 205a as a first shape. Accordingly, it can be intuitively displayed that the pointing signal of the mouse 900a is located in the external input image 1410.

FIG. 14B illustrates that the pointing signal of the mouse 900a is located in the home screen image 1420 while displaying the external input image 1410 and the home screen image 1420.

Referring to FIG. 14B, when the pointing signal of the mouse 900a is located in the external input image 1410, and then moves within the home screen image 1420, the signal processing device 170 can be configured to move a pointer 205 and displayed within the home screen image 1420.

Meanwhile, when the pointing signal of the mouse 900a moves within the home screen image 1420, the emulator 825 in the signal processing device 170 cannot convert an input signal of the mouse 900a into a data packet, and cannot transmit the converted data packet or signal to the notebook 1000.

That is, when the pointing signal of the mouse 900a moves within the home screen image 1420, the signal processing device 170 can control an application related to the home screen image 1420.

Meanwhile, when the point signal of the mouse 900a is located in the home screen image 1420, the signal processing device 170 can be configured to display a shape of a pointer 205b as a second shape different from the first shape. Accordingly, it can be intuitively displayed that the pointing signal of the mouse 900a is located in the home screen image 1420.

FIG. 14C illustrates that the external input image 1410 is controlled by the input signal of the keyboard 903 while displaying the external input image 1410 and the home screen image 1420.

Referring to FIG. 14C, when the keyboard 903 among the input devices is connected to the first interface 605 of the image display apparatus 100, the first interface 605 or the signal processing device 170 receives an input signal of the keyboard 903 through the keyboard device driver 1103.

Meanwhile, when the input signal of the keyboard 903 is received, the emulator 825 in the signal processing device 170 can be configured to convert the input signal of the keyboard 903 into a data packet, and the second interface 610 can be configured to transmit the converted packet to the notebook 1000. Accordingly, the signal processing device 170 can control the notebook 1000 which is the external device.

Meanwhile, when the signal processing device 170 controls the notebook 1000 which is the external device based on the input signal of the keyboard 903, the signal processing device 170c can be configured to highlight (1417) and display the external input image 1410. Accordingly, it can be intuitively displayed that the external input image 1410 is being controlled based on the input signal of the keyboard 903.

FIG. 14D illustrates that the home screen image 1420 is controlled by the input signal of the keyboard 903 while displaying the external input image 1410 and the home screen image 1420.

Referring to FIG. 14D, in response to a specific key input of the keyboard 903 while controlling the external input image 1410 based on the input signal of the keyboard 903 as illustrated in FIG. 14A, the signal processing device 170 can be configured to perform a control authority switching and control the home screen image 1420.

At this time, the specific key input of the keyboard 903 can correspond to an input of an ALT key and a Tab key or a long press input of the Tab key, but is not limited thereto, and can be variously modified.

Meanwhile, when the control authority switching is performed by inputting the specific input, the signal processing device 170 cannot convert the input signal of the keyboard 903 into the data packet, and cannot transmit the converted packet or signal to the notebook 1000.

Meanwhile, when the control authority switching is performed by inputting the specific key input, the signal processing device 170 can control an application related to the home screen image 1420.

Meanwhile, when the signal processing device 170 controls the application related to the home screen image 1420 based on the input signal of the keyboard 903, the signal processing device 170 can be configured to highlight (1427) and display the home screen image 1420. Accordingly, it can be intuitively displayed that the home screen image 1420 is being controlled based on the input signal of the keyboard 903.

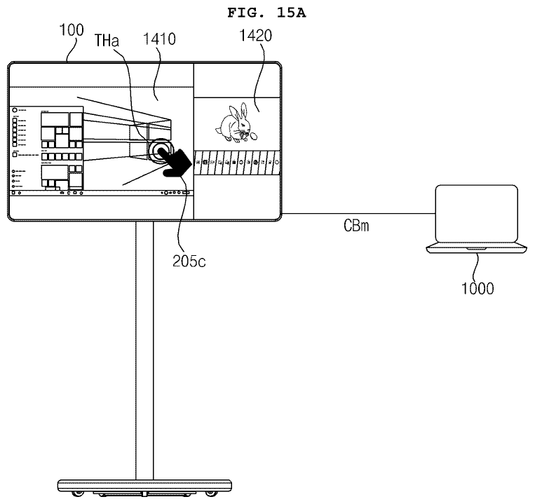

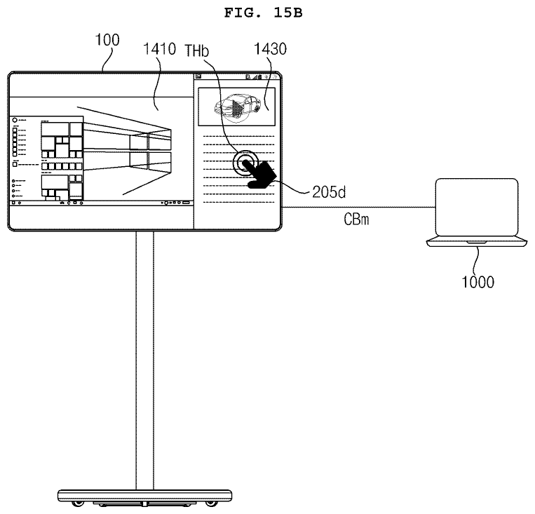

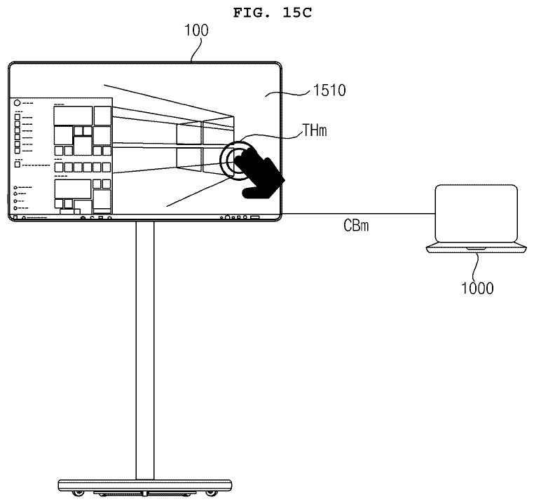

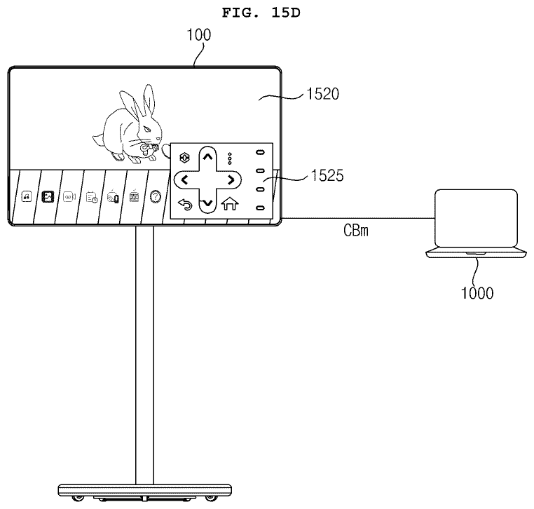

FIG. 15A illustrates that the touch input of the display 180 is located in the external input image 1420 while displaying the external input image 1410 and the home screen image 1420.

Referring to FIG. 15A, the first interface 605 or the signal processing device 170 can be configured to receive the touch input signal of the display 180 through a touch driver 1108.

Meanwhile, when a touch input THa of the display 180 is located within the external input image 1410, the emulator 825 in the signal processing device 170 can be configured to convert the touch input signal of the display 180 into a data packet, and the second interface 610 can be configured to transmit the converted packet to the notebook 1000. Accordingly, the signal processing device 170 can control the notebook 1000 which is the external device.

Meanwhile, when the touch input THa of the display 180 is located in the external input image 1410, the signal processing device 170 can be configured to display a shape of a pointer 205c as a third shape. Accordingly, it can be intuitively displayed that the touch input of the display 180 is located in the external input image 1410.

FIG. 15B illustrates that the touch input of the display 180 is located in the home screen image 1420 while displaying the external input image 1410 and the home screen image 1420.

Referring to FIG. 15B, when a touch input THb of the display 180 is located in the home screen image 1420, the signal processing device 170 can be configured to display control the application related to the home screen image 1420.

Meanwhile, when the touch input THb of the display 180 is in the home screen image 1420, the emulator 825 in the signal processing device 170 cannot convert a touch input signal of the display 180 into a data packet, and not transmit the converted packet or signal to the notebook 1000.

Meanwhile, when the touch input THb of the display 180 is located in the home screen image 1420, the signal processing device 170 can be configured to display a shape of a pointer 205d as a fourth shape different from the third shape. Accordingly, it can be intuitively displayed that the touch input of the display 180 is located in the home screen image 1420.

FIG. 15C illustrates that the external input image 1510 is displayed in a full screen.

Referring to FIG. 15C, when there is the touch input of the display 180 while displaying the external input image 1510 in the full screen, the first interface 605 or the signal processing device 170 receive the touch input signal of the display 180 through the touch driver 1108.

Meanwhile, when the touch input of the display 180 is located in the external input image 1510, the emulator 825 in the signal processing device 170 can be configured to convert the touch input signal of the display 180 into the data packet, and the second interface 610 can be configured to transmit the converted packet to the notebook 1000. Accordingly, the signal processing device 170 can control the notebook 1000 which is the external device.

Meanwhile, the signal processing device 170 can be configured to display an image corresponding to the application 825 in response to a first event based on the input signal while displaying the image corresponding to the image signal received through the second interface 610 in the full screen.

For example, the signal processing device 170 can be configured to perform the control authority switching and control an image corresponding to the application 825 in the external input image 1510, in response to a three-point touch input corresponding to the first event while displaying the external input image 1510 received through the second interface 610 in the full screen.

That is, the signal processing device 170 can be configured to display the home screen image 1520 other than the external input image 1510 as in FIG. 15D, when a touch input corresponding to the first event occurs while displaying the external input image 1510 received through the second interface 610 in the full screen.

FIG. 15D illustrates that the home screen image 1520 is displayed in the full screen.

Meanwhile, the home screen image 1520 can include a menu 1525 for controlling the home screen image 1520.

Meanwhile, when there is the touch input of the display 180 while displaying the home screen image 1520, the signal processing device 170 can control the home screen image 1520 based on the touch input.

Meanwhile, the emulator 825 in the signal processing device 170 cannot convert the touch input signal of the display 180 into a data packet, and not transmit the converted packet or signal to the notebook 1000 when displaying the home screen image 1520 or when controlling the home screen image 1520.

As described above, an image display apparatus according to an embodiment of the present disclosure includes a display, a signal processing device configured to output an image signal to the display, a first interface configured to receive an input signal from an input device, and a second interface wiredly connected to an external device, and the signal processing device is configured to execute an operating system, execute an application on the operating system, and execute an emulator operating based on the input signal from the first interface, and transmit a signal corresponding to the input signal to the executed application or to an external device. Accordingly, it is possible to control the application or the external device based on the input signal from the input device. In particular, the application can be controlled or the external device can be controlled based on various input signals.

Meanwhile, the signal processing device can be configured to execute a kernel, execute the operating system on the kernel, and execute the application on the operating system. Accordingly, it is possible to control the application or the external device based on the input signal from the input device.

Meanwhile, an emulator can control the input signal from the first interface to be received through the kernel or transmit the signal corresponding to the input signal to the external device. Accordingly, it is possible to control the application or the external device based on the input signal from the input device.

Meanwhile, the signal processing device can be further configured to execute a manager configured to determine whether to transmit the signal corresponding to the input signal to the executed application or the external device based on the signal from the emulator. Accordingly, it is possible to control the application or the external device based on the input signal from the input device.

Meanwhile, the emulator can be executed in the operating system. Accordingly, it is possible to control the application or the external device based on the input signal from the input device.

Meanwhile, the manager can be executed in the operating system. Accordingly, it is possible to control the application or the external device based on the input signal from the input device.

Meanwhile, when the control of the external device is needed, the signal processing device can be configured to set first data for controlling the external device to a first value and set second data for controlling the application to a second value. Accordingly, it is possible to control the application or the external device based on the input signal from the input device.

Meanwhile, when the control of the application is needed, the signal processing device can be configured to set the first data for controlling the external device to a third value and set second data for controlling the application to a fourth value. Accordingly, it is possible to control the application or the external device based on the input signal from the input device.

Meanwhile, when the control of the application and the control of the external device are needed, the signal processing device can be configured to set the first data for controlling the external device to the first value and set the second data for controlling the application to the second value. Accordingly, it is possible to control the application or the external device based on the input signal from the input device.

Meanwhile, when the control of the external device is needed, the signal processing device can control an input signal to be converted into a data packet and transmit the converted packet to the external device. Accordingly, it is possible to control the application or the external device based on the input signal from the input device.

Meanwhile, in response to the input device being a keyboard, the emulator can be configured to convert an input signal of the keyboard into the data packet and a second interface can be configured to transmit the converted packet to the external device. Accordingly, it is possible to control the application or the external device based on the input signal from the input device.

Meanwhile, in response to the input device being a mouse, the emulator can be configured to convert an input signal of the mouse into the data packet and the second interface can be configured to transmit the converted packet to the external device. Accordingly, it is possible to control the application or the external device based on the input signal from the input device.

Meanwhile, in response to receiving a touch input signal of the display, the emulator can be configured to convert the touch input signal of the display into the data packet and the second interface can be configured to transmit the converted packet to the external device. Accordingly, it is possible to control the application or the external device based on the input signal from the input device.

Meanwhile, in response to the input device being a remote controller, the emulator can be configured to convert an input signal of the remote controller into the data packet and the second interface can be configured to transmit the converted packet to the external device. Accordingly, it is possible to control the application or the external device based on the input signal from the input device.

Meanwhile, in response to the input device being a game pad, the emulator can be configured to convert an input signal of the game pad into the data packet and the second interface can be configured to transmit the converted packet to the external device. Accordingly, it is possible to control the application or the external device based on the input signal from the input device.

Meanwhile, when the control of the external device is needed, the signal processing device can be configured to convert an input signal into the data packet, and the second interface can be configured to transmit the converted packet to the external device and receive an image signal or an audio signal from the external device. Accordingly, it is possible to control the application or the external device based on the input signal from the input device.

Meanwhile, the signal processing device can be configured to display an image corresponding to the image signal received through the second interface on the display. Accordingly, it is possible to control the application or the external device based on the input signal from the input device.

Meanwhile, the second interface can be configured to transmit a DC voltage to the external device in response to receiving the image signal or the audio signal. Accordingly, it is possible to control the application or the external device based on the input signal from the input device.

Meanwhile, the second interface can be configured to receive the DC voltage from the external device in response to receiving the image signal or the audio signal. Accordingly, it is possible to control the application or the external device based on the input signal from the input device.

Meanwhile, the signal processing device can be configured to display a first image corresponding to the image signal received through the second interface and a second image corresponding to the application together. Accordingly, it is possible to control the application or the external device based on the input signal from the input device.

Meanwhile, the signal processing device can be configured to perform an input control for any one of the first image and the second image based on an event by the input signal. Accordingly, it is possible to control the application or the external device based on the input signal from the input device.

Meanwhile, the signal processing device can be configured to display an image corresponding to the application in response to a first event based on the input signal while displaying the image corresponding to the image signal received through the second interface in a full screen. Accordingly, it is possible to control the application or the external device based on the input signal from the input device.

An image display apparatus according to another embodiment of the present disclosure includes a display, a signal processing device configured to output an image signal to the display, a first interface configured to receive an input signal from an input device, and a second interface wiredly connected to an external device, and the signal processing device is configured to execute an operating system, execute an application on the operating system, and execute an emulator converting the input signal from the first interface into a data packet, and the second interface is configured to transmit the converted packet to an external device. Accordingly, the external device can be controlled based on the input signal from the input device. In particular, the external device can be controlled based on various input signals.

While the preferred embodiments of the present disclosure have been illustrated and described above, the present disclosure is not limited to the aforementioned specific embodiments, various modifications can be made by a person with ordinary skill in the technical field to which the present disclosure pertains without departing from the subject matters of the present disclosure that are claimed in the claims, and these modifications should not be appreciated individually from the technical spirit or prospect of the present disclosure.

What is claimed is:

1. An image display apparatus comprising:
a display;
a signal processing device configured to output an image signal to the display;
a first interface configured to receive an input signal from an input device; and
a second interface wiredly connected to an external device,
wherein the signal processing device is configured to:
execute an operating system, and execute an application on the operating system,
execute an emulator operating based on the input signal from the first interface, and
transmit a signal corresponding to the input signal to the executed application or transmit the signal corresponding to the input signal to the external device.

2. The image display apparatus of claim 1, wherein the signal processing device is configured to execute a kernel, execute the operating system on the kernel, and execute the application on the operating system.

3. The image display apparatus of claim 2, wherein the emulator is configured to:
receive the input signal from the first interface through the kernel, or
transmit the signal corresponding to the input signal to the executed external device through the kernel.

4. The image display apparatus of claim 2, wherein the signal processing device is further configured to execute a manager configured to determine whether to transmit the signal corresponding to the input signal to the executed application or the external device based on the signal from the emulator.

5. The image display apparatus of claim 1, wherein in response to control of the external device being required, the signal processing device is configured to set first data for controlling the external device to a first value and set second data for controlling the application to a second value.

6. The image display apparatus of claim 1, wherein in response to control of the application being required, the signal processing device is configured to set the first data for controlling the external device to a third value and set the second data for controlling the application to a fourth value.

7. The image display apparatus of claim 1, wherein in response to control of the application and control of the external device being required, the signal processing device is configured to set the first data for controlling the external device to the first value and set the second data for controlling the application to a fifth value.

8. The image display apparatus of claim 1, wherein in response to control of the external device being required, the signal processing device is configured to convert the input signal into a data packet and transmit the converted packet to the external device.

9. The image display apparatus of claim 1, wherein in response to the input device being a keyboard, the emulator is configured to convert an input signal of the keyboard into a data packet, and
the second interface is configured to transmit the converted packet to the external device.

10. The image display apparatus of claim 1, wherein in response to the input device being a mouse, the emulator is configured to convert an input signal of the mouse into a data packet, and the second interface is configured to transmit the converted packet to the external device.

11. The image display apparatus of claim 1, wherein in response to receiving a touch input signal of the display, the emulator is configured to convert a touch input signal of the display into a data packet, and the second interface is configured to transmit the converted packet to the external device.

12. The image display apparatus of claim 1, wherein in response to the input device being a remote controller, the emulator is configured to convert an input signal of the remote controller into a data packet, and the second interface is configured to transmit the converted packet to the external device.

13. The image display apparatus of claim 1, wherein in response to the input device being a game pad, the emulator is configured to convert an input signal of the game pad into a data packet, and the second interface is configured to transmit the converted packet to the external device.

14. The image display apparatus of claim 1, wherein in response to control of the external device being required, the signal processing device is configured to convert the input signal into a data packet, and
the second interface is configured to transmit the converted packet to the external device, and receive an image signal or an audio signal from the external device.

15. The image display apparatus of claim 14, wherein the signal processing device is configured to display an image corresponding to the image signal received through the second interface on the display.

16. The image display apparatus of claim 14, wherein the second interface is configured to transmit a DC voltage to the external device in response to receiving the image signal or the audio signal.

17. The image display apparatus of claim 1, wherein the signal processing device is configured to display a first image corresponding to the image signal received through the second interface and a second image corresponding to the application together.

18. The image display apparatus of claim 17, wherein the signal processing device is configured to perform an input control for any one of the first image and the second image based on an event by the input signal.

19. The image display apparatus of claim 1, wherein the signal processing device is configured to display an image corresponding to the application in response to a first event based on the input signal while displaying the image corresponding to the image signal received through the second interface in a full screen.

20. An image display apparatus comprising:
a display;
a signal processing device configured to output an image signal to the display;
a first interface configured to receive an input signal from an input device; and
a second interface wiredly connected to an external device,
wherein the signal processing device is configured to:
execute an operating system, and execute an application on the operating system,
execute an emulator configured to convert the input signal from the first interface into a data packet, and
wherein the second interface is configured to transmit the converted packet to the external device.
